(19) United States
(12) Patent Application Publication
(10) Pub. No.: US 2024/0373303 A1
(43) Pub. Date: Nov. 7, 2024

(54) RADIO RESOURCE MANAGEMENT MEASUREMENTS WITH LOW-POWER SYNCHRONIZATION SIGNALS

(71) Applicant: QUALCOMM Incorporated, San Diego, CA (US)

(72) Inventors: Linhai HE, San Diego, CA (US); Prashant SHARMA, San Marcos, CA (US); Yuchul KIM, San Diego, CA (US)

(21) Appl. No.: 18/653,867

(22) Filed: May 2, 2024

Related U.S. Application Data
(60) Provisional application No. 63/500,197, filed on May 4, 2023.

(51) Int. Cl. H04W 36/00; H04W 36/30

(52) U.S. Cl. CPC H04W 36/0085; H04W 36/302

(57) ABSTRACT

Methods, systems, and devices for wireless communication are described. A user equipment (UE) may receive an indication via a first radio at the UE. The indication may indicate one or more resources for reception of low-power synchronization signals (LP-SSs). The LP-SSs may be associated with a second radio of the UE. The second radio of the UE may be associated with lower power consumption than the first radio at the UE. The UE may receive one or more LP-SSs via the second radio over the one or more resources and in accordance with an idle mode of the UE. The UE may perform a cell reselection in accordance with receiving the one or more LP-SSs while in the idle mode. The UE may associate with one or more network entities in accordance with the cell reselection.

### CROSS REFERENCE

The present application for patent claims the benefit of U.S. Provisional Patent Application No. 63/500,197 by H E et al., entitled “RADIO RESOURCE MANAGEMENT MEASUREMENTS WITH LOW-POWER SYNCHROINIZATION SIGNALS,” filed May 4, 2023, assigned to the assignee hereof, and expressly incorporated by reference herein.

### TECHNICAL FIELD

The following relates to wireless communication, including radio resource management (RRM) measurements with low-power synchronization signals (LP-SSs).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipments (UEs). In some wireless communications systems, a communication device may perform measurements for radio resource management (RRM) using reference signals transmitted by one or more other communication devices. In some cases, existing techniques for RRM may be deficient.

### SUMMARY

The described techniques relate to improved methods, systems, devices, and apparatuses that support radio resource management (RRM) measurements with low-power synchronization signals (LP-SSs). For example, the described techniques provide a framework for obtaining a common metric for LP-SS-based RRM measurements and synchronization signal block based (SSB-based) RRM measurements. In some examples, a user equipment (UE) may receive an indication via a first radio at the UE. For example, the UE may receive an indication of one or more resources for reception of LP-SSs. The LP-SSs may be associated with a second radio of the UE and the second radio of the UE may be associated with lower power consumption than the first radio at the UE. In some examples, the UE may receive one or more LP-SSs via the second radio over the one or more resources and in accordance with an idle mode of the UE. The UE may perform a cell reselection in accordance with receiving the one or more LP-SSs while in the idle mode. For example, the UE may associate with one or more network entities in accordance with the cell reselection.

A method for wireless communications at a UE is described. The method may include receiving, via a first radio of the UE, an indication of one or more resources for reception of LP-SSs associated with a second radio of the UE, where the second radio is associated with lower power consumption than the first radio, receiving, via the second radio, one or more LP-SSs over the one or more resources in accordance with an idle mode of the UE, and performing a cell reselection in accordance with receiving the one or more LP-SSs while in the idle mode, where an association between the UE and one or more network entities is based at least in part on the cell reselection in accordance with receiving the one or more low-power synchronization signals.

A UE for wireless communications at a UE is described. The UE may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) the UE to receive, via a first radio of the UE, an indication of one or more resources for reception of LP-SSs associated with a second radio of the UE, where the second radio is associated with lower power consumption than the first radio, receive, via the second radio, one or more LP-SSs over the one or more resources in accordance with an idle mode of the UE, and perform a cell reselection in accordance with receiving the one or more LP-SSs while in the idle mode, where an association between the UE and one or more network entities is based at least in part on the cell reselection in accordance with receiving the one or more low-power synchronization signals.

Another UE for wireless communications at a UE is described. The UE may include means for receiving, via a first radio of the UE, an indication of one or more resources for reception of LP-SSs associated with a second radio of the UE, where the second radio is associated with lower power consumption than the first radio, means for receiving, via the second radio, one or more LP-SSs over the one or more resources in accordance with an idle mode of the UE, and means for performing a cell reselection in accordance with receiving the one or more LP-SSs while in the idle mode, where an association between the UE and one or more network entities is based at least in part on the cell reselection in accordance with receiving the one or more low-power synchronization signals.

A non-transitory computer-readable medium storing code for wireless communication at a UE is described. The code may include instructions executable by at least one processor (e.g., directly, indirectly, after pre-processing, without pre-processing) to receive, via a first radio of the UE, an indication of one or more resources for reception of LP-SSs associated with a second radio of the UE, where the second radio is associated with lower power consumption than the first radio, receive, via the second radio, one or more LP-SSs over the one or more resources in accordance with an idle mode of the UE, and perform a cell reselection in accordance with receiving the one or more LP-SSs while in the idle mode, where an association between the UE and one or more network entities is based at least in part on the cell reselection in accordance with receiving the one or more low-power synchronization signals.

Some examples of the method, UEs, and non-transitory computer-readable medium described herein may further include operations, features, means, or instructions for performing a received power measurement on a LP-SS of the one or more LP-SSs while in the idle mode, where performing the cell reselection may be based on the received power measurement.

Some examples of the method, UEs, and non-transitory computer-readable medium described herein may further include operations, features, means, or instructions for obtaining a metric based on the received power measurement and a mapping between received power measurements of the one or more LP-SSs and received power measurements of SSBs, where performing the cell reselection may be based on the metric.

Some examples of the method, UEs, and non-transitory computer-readable medium described herein may further include operations, features, means, or instructions for receiving, via the first radio, an indication of an offset between the received power measurements of the one or more LP-SSs and the received power measurements of SSBs, where the mapping may be based on the offset.

Some examples of the method, UEs, and non-transitory computer-readable medium described herein may further include operations, features, means, or instructions for receiving, via the first radio, one or more SSBs and performing a first calibration measurement on the one or more SSBs and a second calibration measurement on the one or more LP-SSs, where the mapping may be based on a difference between the first calibration measurement and the second calibration measurement.

Some examples of the method, UEs, and non-transitory computer-readable medium described herein may further include operations, features, means, or instructions for receiving, via the first radio, system information that indicates a criterion for reception of the one or more LP-SSs received on a serving cell and monitoring for the one or more LP-SSs on the serving cell based on the criterion being satisfied, where receiving the one or more LP-SSs may be based on the monitoring.

In some examples of the method, UEs, and non-transitory computer-readable medium described herein, the criterion corresponds to a threshold signal strength of SSBs received on the serving cell, or a mobility state of the UE, or both.

Some examples of the method, UEs, and non-transitory computer-readable medium described herein may further include operations, features, means, or instructions for determining whether to perform measurements on LP-SSs or SSBs received on a serving cell based on a signal strength of the one or more LP-SSs or a signal strength of one or more SSBs, or both.

Some examples of the method, UEs, and non-transitory computer-readable medium described herein may further include operations, features, means, or instructions for performing received power measurements on the LP-SSs based on the signal strength of the one or more LP-SSs satisfying a first threshold.

Some examples of the method, UEs, and non-transitory computer-readable medium described herein may further include operations, features, means, or instructions for performing received power measurements on the LP-SSs and the SSBs based on the signal strength of the one or more LP-SSs failing to satisfy a first threshold and the signal strength of the one or more SSBs satisfying a second threshold.

In some examples of the method, UEs, and non-transitory computer-readable medium described herein, perform received power measurements on the SSBs based on the signal strength of the one or more SSBs failing to satisfy a third threshold.

In some examples of the method, UEs, and non-transitory computer-readable medium described herein, receiving the indication of the one or more resources may include operations, features, means, or instructions for receiving, on a serving cell, system information that indicates a time and frequency location of resources for reception of LP-SSs on the serving cell, or a non-serving cell, or both, where the one or more resources may be based on the time and frequency location.

In some examples of the method, UEs, and non-transitory computer-readable medium described herein, the system information further indicates an availability of the non-serving cell for reception of the one or more LP-SSs.

In some examples of the method, UEs, and non-transitory computer-readable medium described herein, receiving the indication of the one or more resources may include operations, features, means, or instructions for receiving, on a serving cell, system information that indicates a time and frequency location of resources for reception of SSBs on the serving cell, or a non-serving cell, or both, where the one or more resources may be based on the time and frequency location.

Some examples of the method, UEs, and non-transitory computer-readable medium described herein may further include operations, features, means, or instructions for receiving, via the first radio, a SSB on the non-serving cell based on the system information and determining an availability of the non-serving cell for reception of the one or more LP-SSs based on a received power of the SSB, where receiving the one or more LP-SSs may be based on the availability.

Some examples of the method, UEs, and non-transitory computer-readable medium described herein may further include operations, features, means, or instructions for receiving, via the first radio, system information that indicates a criterion for reception of the one or more LP-SSs received on a non-serving cell and monitoring for the one or more LP-SSs on the non-serving cell based on the criterion being satisfied, where receiving the one or more LP-SSs may be based on the monitoring.

In some examples of the method, UEs, and non-transitory computer-readable medium described herein, the criterion corresponds to a threshold signal strength of SSBs received on the non-serving cell, or a priority associated with the non-serving cell, or both.

A method for wireless communications at a network entity is described. The method may include outputting an indication of one or more resources for reception of LP-SSs associated with a first radio of a UE, where the first radio is associated with lower power consumption than a second radio of the UE and outputting one or more LP-SSs over the one or more resources in accordance with an idle mode of the UE, where an association between the network entity and the UE is based on a cell reselection in accordance with the one or more LP-SSs.

An apparatus for wireless communications at a network entity is described. The apparatus may include at least one processor, memory coupled (e.g., operatively, communicatively, functionally, electronically, or electrically) with the at least one processor, and instructions stored in the memory. The instructions may be executable by the at least one processor (e.g., directly, indirectly, after pre-processing, without pre-processing) the network entity to output an indication of one or more resources for reception of LP-SSs associated with a first radio of a UE, where the first radio is associated with lower power consumption than a second radio of the UE and output one or more LP-SSs over the one or more resources in accordance with an idle mode of the UE, where an association between the network entity and the UE is based on a cell reselection in accordance with the one or more LP-SSs.

Another apparatus for wireless communications at a network entity is described. The apparatus may include means for outputting an indication of one or more resources for reception of LP-SSs associated with a first radio of a UE, where the first radio is associated with lower power consumption than a second radio of the UE and means for outputting one or more LP-SSs over the one or more resources in accordance with an idle mode of the UE, where an association between the network entity and the UE is based on a cell reselection in accordance with the one or more LP-SSs.

A non-transitory computer-readable medium storing code for wireless communication at a network entity is described. The code may include instructions executable by at least one processor (e.g., directly, indirectly, after pre-processing, without pre-processing) to output an indication of one or more resources for reception of LP-SSs associated with a first radio of a UE, where the first radio is associated with lower power consumption than a second radio of the UE and output one or more LP-SSs over the one or more resources in accordance with an idle mode of the UE, where an association between the network entity and the UE is based on a cell reselection in accordance with the one or more LP-SSs.

In some examples of the method, apparatuses, and non-transitory computer-readable medium described herein, the cell reselection may be based on a received power measurement of the one or more LP-SSs and a mapping between received power measurements of the one or more LP-SSs and received power measurements of SSBs.

Some examples of the method, apparatuses, and non-transitory computer-readable medium described herein may further include operations, features, means, or instructions for outputting an indication of an offset between the received power measurements of the one or more LP-SSs and the received power measurements of SSBs, where the mapping may be based on the offset.

Some examples of the method, apparatuses, and non-transitory computer-readable medium described herein may further include operations, features, means, or instructions for outputting one or more SSBs, where the mapping may be based on a difference between a first calibration measurement on the one or more LP-SSs and a second calibration measurement on the one or more SSBs.

In some examples of the method, apparatuses, and non-transitory computer-readable medium described herein, outputting, on a serving cell, system information that indicates a criterion for reception of the one or more LP-SSs received on the serving cell, where the cell reselection may be based on the criterion.

In some examples of the method, apparatuses, and non-transitory computer-readable medium described herein, the criterion corresponds to a threshold signal strength of SSBs output on the serving cell, or a mobility state of the UE, or both.

In some examples of the method, apparatuses, and non-transitory computer-readable medium described herein, the cell reselection may be based on a signal strength of the one or more LP-SSs or a signal strength of one or more SSBs, or both.

In some examples of the method, apparatuses, and non-transitory computer-readable medium described herein, the cell reselection may be in accordance with received power measurements of LP-SSs based on the signal strength of the one or more LP-SSs satisfying a first threshold.

In some examples of the method, apparatuses, and non-transitory computer-readable medium described herein, the cell reselection may be in accordance with received power measurements of LP-SSs and SSBs based on the signal strength of the one or more LP-SSs failing to satisfy a first threshold and the signal strength of one or more SSBs satisfying a second threshold.

In some examples of the method, apparatuses, and non-transitory computer-readable medium described herein, outputting the indication of the one or more resources may include operations, features, means, or instructions for outputting, on a serving cell, system information that indicates a time and frequency location of resources for reception of LP-SSs on the serving cell, or a non-serving cell, or both, where the one or more resources may be based on the time and frequency location.

In some examples of the method, apparatuses, and non-transitory computer-readable medium described herein, the system information further indicates an availability of the non-serving cell for reception of the one or more LP-SSs.

In some examples of the method, apparatuses, and non-transitory computer-readable medium described herein, outputting the indication of the one or more resources may include operations, features, means, or instructions for outputting, on a serving cell, system information that indicates a time and frequency location of resources for reception of SSBs on the serving cell, or a non-serving cell, or both, where the one or more resources may be based on the time and frequency location.

In some examples of the method, apparatuses, and non-transitory computer-readable medium described herein, outputting, on a serving cell, system information that indicates a criterion for reception of the one or more LP-SSs on a non-serving cell, where the cell reselection may be based on the criterion.

In some examples of the method, apparatuses, and non-transitory computer-readable medium described herein, the criterion corresponds to a threshold signal strength of SSBs received on the non-serving cell, or a priority associated with the non-serving cell, or both.

### BRIEF DESCRIPTION OF THE DRAWINGS

FIGS. 1 and 2 each show an example of a wireless communications system that supports radio resource management (RRM) measurements with low-power synchronization signals (LP-SSs) in accordance with one or more aspects of the present disclosure.

FIG. 3 shows an example of a cell region diagram that supports RRM measurements with LP-SSs in accordance with one or more aspects of the present disclosure.

FIG. 4 shows an example of a process flow that supports RRM measurements with LP-SSs in accordance with one or more aspects of the present disclosure.

FIGS. 5 and 6 show block diagrams of devices that support RRM measurements with LP-SSs in accordance with one or more aspects of the present disclosure.

FIG. 7 shows a block diagram of a communications manager that supports RRM measurements with LP-SSs in accordance with one or more aspects of the present disclosure.

FIG. 8 shows a diagram of a system including a device that supports RRM measurements with LP-SSs in accordance with one or more aspects of the present disclosure.

FIGS. 9 and 10 show block diagrams of devices that support RRM measurements with LP-SSs in accordance with one or more aspects of the present disclosure.

FIG. 11 shows a block diagram of a communications manager that supports RRM measurements with LP-SSs in accordance with one or more aspects of the present disclosure.

FIG. 12 shows a diagram of a system including a device that supports RRM measurements with LP-SSs in accordance with one or more aspects of the present disclosure.

FIGS. 13 and 14 show flowcharts illustrating methods that support RRM measurements with LP-SSs in accordance with one or more aspects of the present disclosure.

### DETAILED DESCRIPTION

A wireless communications system may include one or more communication devices (e.g., user equipments (UEs)), which may support multiple operation modes. For example, a UE may support an active mode in which the UE may communicate uplink traffic or downlink traffic with a network entity via a serving cell. In some examples, to facilitate communications at the UE during the active mode, the UE may include a main radio. The UE may use the main radio to transmit the uplink traffic or receive the downlink traffic. In some examples, the network entity may lack downlink traffic to transmit to the UE or the UE may lack uplink traffic to transmit to the network entity. In such examples, the UE may enter into the idle mode (or the inactive mode), for example, to reduce power consumption at the UE.

In some examples, the UE may perform one or more procedures while operating in the idle mode. For example, the UE may perform a paging procedure in which the UE may periodically monitor for paging signals from the network entity. The paging signals may indicate that the network entity intends to transmit downlink traffic to the UE. As such, the UE may transition from the idle mode to the active mode in response to detecting a paging signal. Additionally, the UE may perform a radio resource management (RRM) procedure while operating in the idle mode. In some examples, as part of the RRM procedure, the UE may periodically perform RRM measurements on reference signals (e.g., synchronization signal blocks (SSBs)) transmitted from the network entity on the serving cell or from one or more other network entities on one or more non-serving cells. The UE may use the RRM measurements for cell reselection. For example, the UE may use the RRM measurements to identify a cell to associate with (e.g., to maintain a network connection).

In some examples, the UE may be configured with a low-power wakeup radio (LP-WUR) capable of detecting signals with a relatively low receive power. The LP-WUR may consume less power relative to the main radio at the UE. In some examples, the UE may use the LP-WUR for paging reception to conserve power during the idle mode. In some examples, however, a quantity of power that the UE may conserve by using the LP-WUR for paging reception during the idle mode may be small relative to a quantity of power consumed at the UE for RRM measurements during the idle mode. In other words, power savings attainable at the UE by using the LP-WUR for paging reception may be relatively small compared to the power consumption associated with using the main radio for RRM measurements. To increase the power savings attainable by the LP-WUR, the UE may use the LP-WUR for RRM measurements. For example, the network entity may transmit low-power synchronization signals (LP-SSs) detectable via the LP-WUR, such that the UE may offload RRM measurements from the main radio to the LP-WUR.

In some examples, however, offloading RRM measurements from the main radio to the LP-WUE may degrade a performance of cell reselection at the UE. For example, a coverage attainable by LP-SSs may be different from (e.g., shorter than) a coverage attainable by the SSBs. Additionally, or alternatively, the LP-WUR may not support frequency retuning and, as such, may be incapable of using the LP-WUR for RRM measurements across multiple frequencies, which may degrade a performance of cell reselection. In some examples, the UE may use both the LP-SSs and the SSBs for RRM measurements. However, a received power metric obtained through measurement of the LP-SSs via the LP-WUR and a received power metric obtained through measurement of the SSBs via the main radio may be inconsistent. In some examples, using inconsistent measurements for cell reselection may degrade a performance of wireless communications at the UE.

Various aspects of the present disclosure relate to techniques for RRM measurements with LP-SSs and, more specifically, to a framework for obtaining a common metric for LP-SS-based RRM measurements and SSB-based RRM measurements. For example, a UE may receive a resource indication from a network entity via the main radio. The resource indication may indicate one or more resources for reception of one or more of LP-SSs via a radio at the UE that may be associated with lower power consumption than the main radio (e.g., via the LP-WUR). In some examples, the UE may receive one or more LP-SSs via the LP-WUR over the one or more resources in accordance with an idle mode of the UE. In such examples, the UE may perform a cell reselection in accordance with receiving the LP-SS while in the idle mode. For example, the UE may use the LP-WUR to perform one or more RRM measurements on the LP-SS. In such an example, the UE may map the one or more RRM measurements to a metric that may be common to both LP-SS-based measurements and SSB-based measurements. The UE may use the metric for cell reselection. For example, the UE may use the metric to identify a cell to associated with in accordance with the cell reselection procedure.

Aspects of the subject matter described herein may be implemented to realize one or more of the following potential advantages. For example, the techniques employed by the described communication devices may provide benefits and enhancements to the operation of the communication devices, including enabling use of an LP-WUR for RRM measurements for improved cell reselection. The operations performed by the described communication devices to improve cell reselection may include performing a cell reselection in accordance with receiving one or more LP-SSs while in operating in an idle mode. In some examples, operations performed by the described communication devices may also support increased reliability of communications within a wireless communications system, among other benefits.

Aspects of the disclosure are initially described in the context of wireless communications systems. Aspects of the disclosure are also described in the context of a cell region diagram and a process flow. Aspects of the disclosure are further illustrated by and described with reference to apparatus diagrams, system diagrams, and flowcharts that relate to RRM measurements with LP-SSs.

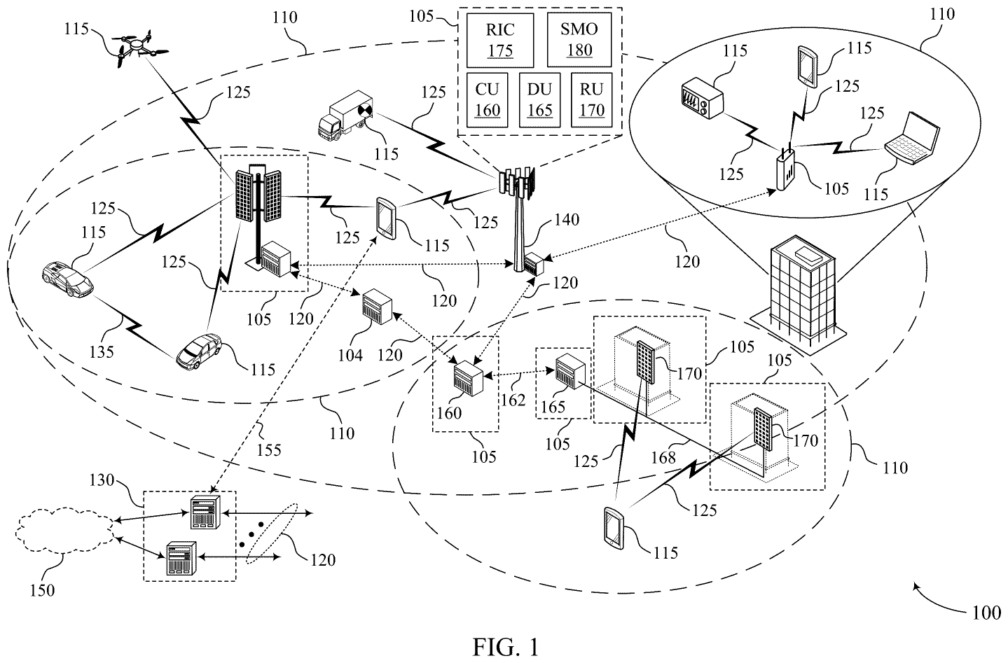

FIG. 1 shows an example of a wireless communications system 100 that supports RRM measurements with LP-SSs in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support RRM measurements with LP-SSs as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, or a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 may be configured with an LP-WUR capable of detecting signals with a relatively low receive power. As such, the LP-WUR may consume less power relative to a main radio at the UE 115. In some examples, the UE 115 may use the LP-WUR for paging reception to conserve power during the idle mode. In some examples, however, a quantity of power that the UE 115 may conserve by using the LP-WUR for paging reception during the idle mode may be small relative to a quantity of power consumed at the UE 115 for RRM measurements during the idle mode. In other words, power savings attainable at the UE 115 by using the LP-WUR for paging reception may be relatively small compared to the power consumption associated with using the main radio for RRM measurements. To increase the power savings attainable by the LP-WUR, the UE 115 may use the LP-WUR for RRM measurements. For example, the network entity 105 may transmit LP-SSs detectable via the LP-WUR, such that the UE 115 may offload RRM measurements from the main radio to the LP-WUR.

In some examples, however, offloading RRM measurements from the main radio to the LP-WUE may degrade a performance of cell reselection at the UE 115. For example, a coverage attainable by LP-SSs may be different from (e.g., shorter than) a coverage attainable by the SSBs. Additionally, or alternatively, the LP-WUR may not support frequency retuning and, as such, may be incapable of using the LP-WUR for RRM measurements across multiple frequencies, which may degrade a performance of cell reselection. In some examples, the UE 115 may use both the LP-SSs and the SSBs for RRM measurements. However, a received power metric obtained through measurement of the LP-SSs via the LP-WUR and a received power metric obtained through measurement of the SSBs via the main radio may be inconsistent. In some examples, using inconsistent measurements for cell reselection may degrade a performance of wireless communications at the UE 115.

In some examples, the wireless communications system 100 may support a framework for obtaining a common metric for LP-SS-based RRM measurements and SSB-based RRM measurements. For example, the UE 115 may receive a resource indication from the network entity 105 via the main radio. The resource indication may indicate one or more resources for reception of one or more of LP-SSs via the LP-WUR. In some examples, the UE 115 may receive one or more LP-SSs via the LP-WUR over the one or more resources in accordance with the idle mode of the UE 115. In such examples, the UE 115 may perform a cell reselection in accordance with receiving the LP-SS while in the idle mode. For example, the UE 115 may use the LP-WUR to perform one or more RRM measurements on the LP-SS. In such an example, the UE 115 may map the one or more RRM measurements to a metric that may be common to both LP-SS-based measurements and SSB-based measurements. The UE 115 may use the metric to identify a cell in accordance with a cell reselection procedure. In some examples, performing a cell reselection procedure in accordance with receiving one or more LP-SSs while in operating in an idle mode, may enable the UE 115 to increase a reliability of communications within the wireless communications system 100, among other benefits.

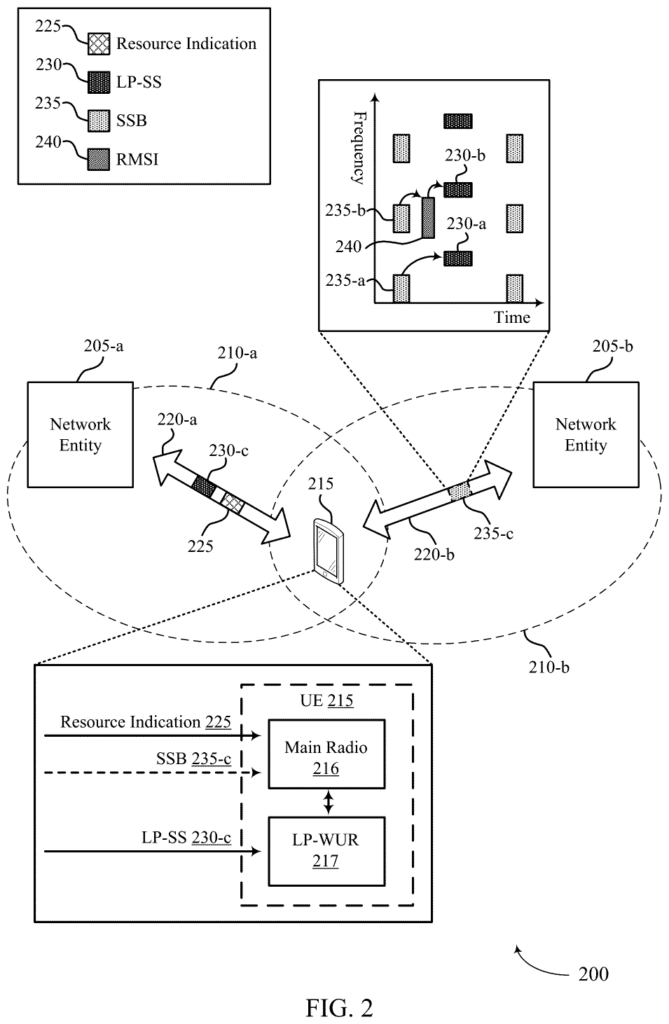

FIG. 2 shows an example of a wireless communications system 200 that supports RRM measurements with LP-SSs in accordance with one or more aspects of the present disclosure. The wireless communications system 200 may implement or be implemented at one or more aspects of the wireless communications system 100. For example, the wireless communications system 200 may include a UE 215, which may be an example of a UE 115 illustrated by and described with reference to FIG. 1. The wireless communications system 200 may also include a network entity 205-a and a network entity 205-b, which may each be an example of one or more of the network entities 105 (e.g., a CU, a DU, an RU, a base station, an IAB node, or one or more other network nodes) illustrated by and described with reference to FIG. 1 The network entity 205-a may communicate with the UE 215 via a communication link 220-a and the network entity 205-b may communicate with the UE 215 via a communication link 220-b. The communication links 220 may be examples of a communication link 125 (e.g., access links, Uu interfaces) illustrated by and described with reference to FIG. 1. For example, the communication links 220 may be examples of downlinks or uplinks, or both.

The UE 215 may communicate with the network entity 205-a within a coverage area 210-a and with the network entity 205-b via a coverage area 210-b. The coverage areas 210 may be examples of a coverage area 110 illustrated by and described with reference to FIG. 1. For example, the network entity 205-a may serve a first cell (e.g., a first logical communication entity) providing the coverage area 210-a and the network entity 205-b may serve a second cell (e.g., a second logical communication entity) providing the coverage area 210-b. That is, the network entity 205-a may support wired or wireless communications within the coverage area 210-a via the first cell and the network entity 205-b may support wired or wireless communications within the coverage area 210-b via the second cell. The wireless communications system 200 may include features for improved communications between the network entities 205 and the UE 215, among other benefits.

In the example of FIG. 2, the network entity 205-a may establish a connection with the UE 215 via the first cell. That is, the network entity 205-a may serve the UE 215 via the first cell. As such, the first cell may be referred to as a serving cell. As described herein, the serving cell may refer to a cell in which the UE 215 may be camped. For example, the serving cell may refer to a cell selected (e.g., chosen from multiple neighboring cells) at the UE 215 during a cell selection or cell reselection procedure. Accordingly, the serving cell may also be referred to as an activated serving cell. The second cell served by the network entity 205-b may be referred to as a non-serving cell or a neighboring cell. In some examples, the non-serving cell may refer to a cell unselected during a cell selection or cell reselection procedure. Accordingly, the non-serving cell may also be referred to as a non-activated cell (e.g., a non-activated serving cell). In some examples, the serving cell and the non-serving cell may be differentiated based on cell identifiers. For example, the serving cell may be associated with a cell identifier (e.g., a physical cell identifier (PCID) or a virtual cell identifier (VCID)) that may distinguish the serving cell from other (e.g., neighboring) cells supported by other (e.g., neighboring) network entities, such as the non-serving cell supported by the network entity 205-b. For example, the serving cell (e.g., the activated serving cell) may be associated with a first cell identifier and the second cell (e.g., the non-activated serving cell) may be associated with a second cell identifier that is different from the first cell identifier.

In some examples, the wireless communications system 200 may support multiple operation modes at the UE 215. For example, the UE 215 may operate in an active mode (e.g., an RRC active mode) during which the UE 215 may communicate with the network entity 205-a via the first cell (e.g., via the communication link 220-a). In some examples, such as to facilitate wireless communications at the UE 215 during the active mode, the UE 215 may include a main radio 216. For example, the UE 215 may use the main radio 216 to receive one or more downlink messages or to transmit one or more uplink messages. In some other examples, the UE 215 may operate in an idle mode or inactive mode (e.g., an RRC idle mode or RRC inactive mode). For example, the network entity 205-a may lack data (e.g., downlink traffic) to transmit to the UE 215 or the UE 215 may lack data (e.g., uplink traffic) to transmit to the network entity 205-a. In such an example, the UE 215 may enter into the idle mode (or the inactive mode). For example, in response to determining a lack of uplink traffic or a lack of downlink traffic, or both, the UE 215 may enter into the idle mode to reduce power consumption at the UE 215.

In some examples, such as while operating in the idle mode or the inactive mode, the UE 215 may perform one or more procedures, such as a paging procedure or an RRM procedure. That is, in RRC idle or RRC inactive, the UE 215 may perform RRM and paging. In some examples, such procedure may be relatively power consuming. For example, while the UE 215 is operating in the idle mode, the network entity 205-a may determine to transmit data (e.g., downlink messages) to the UE 215. To reduce a likelihood of the UE 215 failing to receive the data, the UE 215 may perform a paging procedure in which the UE 215 may periodically monitor for paging signals that indicate that the network entity 205-a has data to transmit to the UE 215. In other words, to reduce a likelihood of the UE 215 failing to receive a downlink message while operating in the idle mode, the UE 215 may use the main radio 216 to periodically monitor for paging signals that may indicate, to the UE 215, to transition from the idle mode to the active mode. In some examples, the UE 215 may monitor for paging signals in accordance with a discontinuous reception (DRX) cycle. For example, the network entity 205-a may configure the UE 215 to periodically monitor for paging signals while operating in the idle mode in accordance with the DRX cycle (e.g., an idle mode DRX (I-DRX) cycle). In some examples, the network entity 205-a may configure the UE 215 to monitor for paging signals during a paging occasion which may occur during a DRX cycle (e.g., may configure the UE 215 to monitor for paging signals during each I-DRX cycle).

In some other examples, such as during an RRM procedure, the UE 215 may periodically perform RRM measurements on reference signals transmitted from the network entity 205-a or the network entity 205-b, or both. For example, one or both of the network entities 205 may transmit SSBs 235 for RRM measurements at the UE 215. The RRM measurements may include signal strength measurements (e.g., reference signal received power (RSRP) measurements) or signal quality measurements (e.g., reference signal received quality (RSRQ) measurements). For example, the RRM measurements may include RSRSP measurements (e.g., L3-RSRP measurements) or RSRQ measurements (or both) on reference signals, such as the SSBs 235. In other words, as part of the RRM procedure, the UE 215 may use the main radio 216 to periodically receive and perform RRM measurements on one or more of the SSBs 235, which may be transmitted by the serving cell or the non-serving cell (or both).

In some examples, the UE 215 may perform RRM measurements on the serving cell to determine whether a signal strength or quality of reference signals transmitted on the serving cell (e.g., a current serving cell, the activated serving cell) satisfies a threshold. In other words, the UE 215 may use RRM measurements performed on SSBs transmitted via the serving cell to determine whether the serving cell may be of suitable quality to maintain the communication link 220-a.

In some examples, the UE 215 may determine that the signal strength or the quality of reference signals transmitted on the serving cell fail to satisfy a threshold (e.g., that the serving cell may not be of suitable quality to maintain the communication link 220-a). In such an example, the UE 215 may perform a cell reselection procedure to select another cell (e.g., to determine another cell to associated with). In some examples, the UE 215 may determine a cell to select (or reselect) during the cell reselection procedure based on RRM measurements. As such, the UE 215 may periodically measure (e.g., as part of an RRM procedure during the idle mode) a signal strength of the serving cell and the non-serving cell (e.g., the serving cell and one or more neighbor cells) for cell reselection (e.g., to prepare for a cell reselection procedure).

For example, in accordance with an RRM procedure during the idle mode, the UE 215 may periodically perform one or multiple (e.g., two) types of RRM measurements. For example, the UE 215 may perform RRM measurements on the serving cell (e.g., serving cell measurements) or RRM measurements on the non-serving cell (e.g., neighboring cell measurements, non-serving cell measurements), or both. In some examples, such as examples in which the UE 215 may be camped on the serving cell (e.g., the first cell served by the network entity 205-a), the UE 215 may perform RRM measurements (e.g., RSRP measurements, RSRQ measurements) on reference signals (e.g., SSBs) transmitted from the network entity 205-a. That is, while the UE 215 may be camped on the serving cell, the UE 215 may perform serving cell measurements. During idle mode, the UE 215 may determine whether to perform RRM measurements on the serving cell or non-serving cells (or both) based on whether a signal strength or quality (or both) of the reference signals transmitted via the serving cell satisfy a threshold (e.g., whether the measured signal strength or a measured quality is capable of maintaining a connection with the network entity 205-a). In other words, the UE 215 may determine whether to perform serving cell measurements or non-serving cell measurements (or both) based on one or more thresholds (e.g., criterion). For example, the UE 215 may be configured with a cell reselection criterion described in accordance with Equation 1:

Srxlev>SIntraSearchP and Squal>SIntraSearchQ (1)

in which Srxlev may correspond to a cell selection received level value (in dB), SIntraSearchP may specify the Srxlev threshold (in dB) for intra-frequency measurements, Squal may specify a cell selection quality value (in dB), and SIntraSearchQ may specify the Squal threshold (in dB) for intra-frequency measurements. In other words, Srxlev may correspond to a signal strength measured for the serving cell, SIntraSearchP may correspond to a signal strength threshold, Squal may correspond to a signal quality measured for the serving cell, and SIntraSearchQ may correspond to a signal quality threshold. As such, the UE 215 may be configured to refrain from performing RRM measurements (e.g., intra-frequency RRM measurements, inter-frequency RRM measurements) on the non-serving cell for examples in which a signal strength measured for the serving cell satisfies the signal strength threshold (e.g., a value of Srxlev is greater than a value of SIntraSearchP) and a signal quality measure for the serving cell satisfies the quality threshold (e.g., a value of Squal is greater than a value of SIntraSearchQ). In other words, the UE 215 may be configured to refrain from performing RRM measurements on the non-serving cell if RRM measurements performed on the serving cell satisfy the criterion described in accordance with Equation 1. Accordingly, the UE 215 may be configured to perform RRM measurements (e.g., intra-frequency RRM measurements, inter-frequency RRM measurements) on the non-serving cell for examples in which a signal strength measured for the serving cell fails to satisfy the signal strength threshold (e.g., a value of Srxlev is less than a value of SIntraSearchP) and a signal quality measure for the serving cell fails to satisfy the quality threshold (e.g., a value of Squal is less than a value of SIntraSearchQ). In other words, if the RRM measurements performed on the serving cell fail to satisfy the criterion described in accordance with Equation 1, the UE 215 may determine to perform RRM measurements (e.g., intra-frequency RRM measurements, inter-frequency RRM measurements) on the non-serving cell.

In some examples, parameter Srxlev may be described in accordance with the following Equation 2:

Srxlev=Qrxlevmeas−(Qrxlevmin+Qrxlevminoffset)−Pcompensation−Qoffsettemp(2)

in which Qrxlevmeas may correspond to a measured cell reception level value (e.g., a value of RSRP measurements), Qrxlevmin may correspond to a reception level parameter for the cell (in dBm), Qrxlevminoffset may correspond to a reception level offset for the cell (in dB), Pcompensation may correspond to a compensation parameter, and Qoffsettemp may correspond to an offset to be used for cell selection and re-selection. Additionally, the parameter Squal may be described in accordance with the following Equation 3:

Squal=Qqualmeas−(Qqualmin+Qqualminoffset)−Qoffsettemp (3)

in which Qqualmeas may correspond to a measured cell quality value (e.g., a value of RSRQ measurements), Qqualmin may correspond to a quality level parameter for the cell (in dBm), and Qqualminoffset may correspond to a quality level offset for the cell (in dB).

In some examples, the network entities 205 may operate on a same frequency. In such examples, the UE 215 may perform cell reselection (e.g., may associate with the serving cell or the non-serving cell) based on a signal strength (or quality) of reference signals transmitted via the serving cell relative to a signal strength (or quality) of reference signals transmitted via the non-serving cell. That is, the UE 215 may select the serving cell or the non-serving cell based on a value of RRM measurements performed on the serving cell relative to a value of RRM measurements performed on the non-serving cell. In other words, cell reselection for inter-frequency (or intra-frequency) measurements of equal priority may be based on a cell ranking (Rs/Rn), which may be a function of RSRP measurements or RSRQ measurements (or both).

In some other examples, the network entities 205 may operate via multiple (e.g., different) frequencies. In such examples, the UE 215 may perform cell reselection (e.g., may associate with the serving cell or the non-serving cell) based on a value of RRM measurements performed on the serving cell relative to a value of RRM measurements performed on the non-serving cell and based on a respective priority of a frequency associated with the non-serving cell relative to a priority of a frequency associated with the serving cell). In other words, cell reselection for inter-frequency measurements may be based on a value of Srxlev, a value of Squal, and frequency priorities (e.g., of the serving cell and the non-serving cell). That is, cell reselection to a cell with a higher priority frequency or an inter-RAT frequency may be based on a value of Srxlev, a value of Squal, and frequency priorities.

In some examples, the UE 215 may be configured with an LP-WUR 217, which may be capable of detecting signals with a relatively low receive power (e.g., due to an unconventional radio receiver design). For example, the LP-WUR 217 may be capable of detecting one or more types of low-power wakeup signals (LP-WUSs). In some examples, the LP-WUR 217 may be capable of detecting a type of LP-WUS that may be based on a modulation scheme (e.g., an on-off keying (OOK) modulation scheme), which may enable the LP-WUR 217 (e.g., may enable radios capable of achieving relatively low receive powers, such as receive powers less than 1 mA). An OOK modulation scheme may refer to a modulation scheme that includes keying a sinusoidal carrier signal on and off with a unipolar binary signal. In some examples, OOK may be relatively similar to two-level amplitude-shift keying (ASK).

In some examples, the UE 215 may use the LP-WUR 217 for paging reception during the idle mode. That is, the network entity 205-a may transmit LP-WUSs for paging reception at the UE 215. In some examples, the LP-WUR 217 may be paired with the main radio 216. In such examples, the UE 215 may determine to wake up (e.g., transition from the idle mode to the active mode) in response to detecting an LP-WUS via the LP-WUR 217 that indicates a page (e.g., that the network entity 205-a has data to transmit to the UE 215). In other words, the UE 215 may use the LP-WUR 217 to monitor for paging signals during the idle mode and may transition from the idle mode to the active mode (e.g., and communicate via the main radio 216) in response to detecting an LP-WUS via the LP-WUR 217. In some examples, using the LP-WUR 217 for paging reception may consume less power at the UE 215 than using the main radio 216 for paging reception. That is, using the LP-WUR 217 to detect LP-WUSs may consume less power at the UE 215 than using the main radio 216 to detect other types of paging signals). As such, using the LP-WUR 217 for paging reception may enable the UE 215 to conserve power during the idle mode. That is, the network entity 205-a (or the network entity 205-b) may use LP-WUSs to avoid paging reception at the UE 215 via the main radio 216 and, as such, may reduce the power consumed at the UE 215 due to the paging procedure. In other words, to enable power savings via the LP-WUR 217 for paging during the idle mode, the network entity 205-a may transmit LP-WUSs, which may be detectable via the LP-WUR 217 (e.g., rather than using other paging signals, which may be detectable via the main radio 216).

In some examples, however, a quantity of power that the UE 215 may conserve by using the LP-WUR 217 for paging reception during the idle mode may be small relative to a quantity of power consumed at the UE 215 for RRM measurements during the idle mode. For example, an RRM measurement occasion (e.g., each RRM measurement occasion) for a cell (e.g., the serving cell, the first cell) may consume quadruple the quantity of power as one monitoring occasion for paging reception. That is, the UE 215 may consume a quantity of power performing an RRM measurement on a reference signal transmitted via the serving cell (or via the non-serving cell) and the quantity may be about four times a quantity of power the UE 215 may consume monitoring for paging signals transmitted via the serving cell (or non-serving cell) during one monitoring occasion. In other words, for each RRM measurement on the serving cell, the UE 215 may expend about four times the power that the UE 215 may expended monitoring for paging signals during one paging occasion. As such, a quantity of power conserved by using the LP-WUR 217 for paging reception may be relatively small compared to a quantity of power consumed by using the main radio 216 for RRM measurements. For example, use of the LP-WUR 217 for paging reception may reduce power consumed by the paging procedure by about 75%, which may correspond to (e.g., translate to) about a 15% savings of power (e.g., total power) for the UE 215 in the idle mode. In some examples, the network entities 205 may support a type of LP-WUS, which may be an example of a WUS based on a physical downlink control channel (PDCCH). That is, the network entities 205 may support a PDCCH-based WUS (PDCCH-WUS), which may be detectable by the LP-WUR 217. In such examples, use of the PDCCH-WUS may enable the UE 215 to reduce 25% of power consumed by paging reception. In other words, use of the LP-WUR 217 for reception of PDCCH-WUSs may enable the UE 215 to achieve about a 10% gain in power savings (e.g., during the idle mode). In some examples, however, a gain of about 10% in power savings may fail to account for (e.g., rationalize) use of the LP-WUR 217 at the UE 215 (e.g., for paging reception during the idle mode). In other words, power savings attainable by using the LP-WUR 217 for paging reception may be relatively small (e.g., trivial) compared to the power consumption associated with using the main radio 216 for RRM measurements.

To increase the power savings attainable by the LP-WUR 217, the UE 215 may use the LP-WUR 217 for multiple procedures performed at the UE 215 during idle mode operations. In other words, to increase (e.g., maximize) power savings attainable at the UE 215 by using the LP-WUR 217, the UE 215 may not constrain power enhancements enabled via the LP-WUR 217 during idle mode operations to paging reception. For example, the UE 215 may use the LP-WUR 217 for paging reception and for RRM measurements. In some examples, to enable use of the LP-WUR 217 for RRM measurements, the network entities 205 may support another type of low-power signal, which may be referred to as an LP-SS. For example, one or both of the network entities 205 may support transmission of LP-SSs 230, which may be detectable at the UE 215 via the LP-WUR 217. In some examples, the UE 215 may use the LP-SSs 230 for synchronization with one or both of the network entities 205 (e.g., to synchronize a clock at the UE 215 with one or both of the network entities 205).

Additionally, or alternatively, the UE 215 may use the LP-SSs 230 to measure a signal strength or quality (or both) associated with one or more cells via the LP-WUR 217. That is, the UE 215 may use the LP-SSs 230 for RRM measurements. In some examples, the LP-SSs 230 may include a sequence (e.g., a predefined sequence). That is, the LP-SSs may include a sequence transmitted by the network entities 205 (e.g., each serving cell). In some examples, an LP-SS (e.g., one of the LP-SSs 230) may be scrambled by a PCI (e.g., a PCID) or may carry a PCI in a payload of the LP-SSs 230 (e.g., for cell identification). In some examples, the payload of the LP-SSs 230 may include other information, such as information usable at the UE 215 for one or more idle mode procedures. In some examples, the LP-SSs 230 may be transmitted using a same waveform or modulation as one or more other types of low-power signals (e.g., LP-WUSs). For example, the LP-SSs 230 may be transmitted using OOK modulation or some other type of modulation that may enable the LP-SSs 230 to be detected via the LP-WUR 217. In other words, the UE 215 may use the LP-WUR 217 to receive (and measure) the LP-SSs 230, which may reduce power consumption at the UE 215. That is, the UE 215 may use the LP-WUR 217 (e.g., a same LP-WUR used for paging reception) to receive and measure the LP-SSs 230, which may consume less power than the main radio 216 that is used to receive and measure the SSBs 235.

As illustrated in the example of FIG. 2, a time and frequency location of one or more of the LP-SSs 230 may be determined based on SSBs or system information (e.g., remaining minimum system information (RMSI)), or both. For example, the time and frequency location of the LP-SSs 230 may be determined based on a synchronization raster, which may be indicative of a time and frequency location of the SSBs 235. That is, locations of the LP-SSs 230 may be defined (e.g., predefined) based on offsets in time or frequency (or both) with respect the synchronization raster (e.g., with respect to SSBs via the synchronization raster). Additionally, or alternatively, locations of the LP-SSs 230 and other configurations may be provided in RMSI (e.g., an RMSI 240). In some examples, a time and frequency location of one or more of the LP-SSs 230 may be determined based on an offset (e.g., in time and frequency) relative to the synchronization raster. For example, the synchronization raster may indicate a frequency location of one or more cell-defining SSBs (e.g., an SSB 235-a) that the UE 215 may use for system acquisition for a cell (e.g., a primary cell (PCell) served by the network entity 205-a). In such an example, the UE 215 may scan a frequency band in accordance with the synchronization raster to detect the SSB 235-a. In some examples, the UE 215 may detect the SSB 235-a and, as such, identify a time and frequency location of the SSB 235-a. The UE 215 may apply the offset to the time and frequency location of the SSB 235-a to determine a time and frequency location of an LP-SS 230-a. In other words, the UE 215 may determine the time and frequency location of the LP-SS 230-a based on an offset relative to the time and frequency location of the SSB 235-a.

In some other examples, a time and frequency location of one or more of the LP-SSs 230 may be determined based on RMSI. For example, the time and frequency location of the LP-SSs 230 may be broadcast in system information (e.g., in a system information block (SIB), such as a SIB1 carrying RMSI). In the example of FIG. 2, an RMSI 240 may indicate a time and frequency location of an LP-SS 230-b. In some examples, the RMSI 240 may be associated with an SSB 235-b (e.g., a cell-defining SSB). For example, the SSB 235-a may indicate one or more parameters that the UE 215 may use to detect the RMSI 240 (e.g., to acquire a SIB1 carrying the RMSI 240). That is, the UE 215 may detect the SSB 235-b, detect the RMSI 240 based on information indicated via the SSB 235-b, and determine a time and frequency location of the LP-SS 230-b based on information indicated via the RMSI 240. In some examples, the RMSI 240 may carrier one or more other configurations, such as configurations for the LP-SSs 230. In other words, the locations of the LP-SSs 230 and one or more other configurations (e.g., configurations associated with the LP-SSs 230) may be provided in RMSI (e.g., the RMSI 240).

In some examples, the network entity 205-a (or the network entity 205-b) may transmit one or more of the LP-SSs 230 in accordance with a periodicity. That is, the LP-SSs 230 may be examples of reference signals that one or both of the network entities 205 may transmit periodically. In some examples, a periodicity associated with the LP-SSs 230 may be longer than a periodicity associated with the SSBs 235. That is, a periodicity at which one or both of the network entities 205 may transmit the LP-SSs 230 may be longer than a periodicity at which one or both of the network entities 205 may transmit the SSBs 235. In other words, the LP-SSs 230 may be transmitted less frequently than the SSBs 235. In some examples, the periodicity associated with the LP-SSs 230 may be based on a periodicity at which the UE 215 may perform RRM measurements. For example, RRM measurements may be performed in accordance with a quantity of I-DRX cycles (or extended DRX (eDRX) cycles). That is, the periodicity of RRM measurements may be based on repetitions of I-DRX cycles or eDRX cycles (e.g., repetitions of paging cycles) configured at the UE 215. As such, the UE 215 may perform RRM measurements relatively infrequently. In some examples, performing RRM measurements relatively infrequently may reduce overhead associated with RRM procedures.

In some examples, the UE 215 may offload RRM measurements from the main radio 216 to the LP-WUR 217. That is, the UE 215 may use the LP-SSs 230 for RRM measurements (e.g., rather than the SSBs 235). For example, in some instances, the LP-SSs 230 may have a same or relatively similar (e.g., comparable) coverage as the SSBs 235 (e.g., through use of repetitions). That is, one or both of the network entities 205 may transmit repetitions of the LP-SSs 230 to achieve a same or relatively similar coverage as the SSBs 235. In such an example, the UE 215 may use the LP-SSs 230 to offload RRM measurements from the main radio 216 to the LP-WUR 217. In some examples, however, offloading RRM measurements for serving cells (e.g., offloading serving cell measurements) may degrade a performance of cell selection. For example, in some other instances, a coverage attainable by LP-SSs 230 may be different from a coverage attainable by the SSBs 235. That is, in some instances, the coverage attainable by the LP-SSs 230 may be shorter than the coverage attainable by the SSBs 235. In such an example, using the LP-SSs 230 for serving cell measurements (e.g., rather than using the SSBs 235 for serving cell measurements) may degrade a performance of cell reselection at the UE 215. Additionally, or alternatively, offloading RRM measurements for non-serving cells (e.g., offloading serving cell measurements) from the main radio 216 to the LP-WUR 217 may degrade a performance of cell selection. For example, one or more neighboring cells (e.g., the network entity 205-b) may not support LP-SS or may use frequencies different from a frequency that the LP-WUR 217 may be tuned to. For example, the LP-WUR 217 may be tuned to a frequency and may not support frequency retuning. In such an example, the UE 215 may be incapable of using the LP-WUR 217 for inter-frequency RRM measurements. That is, the UE 215 may be incapable of using the LP-WUR 217 to preform RRM measurements for multiple cells that may use multiple (e.g., different) frequencies. In other words, some UEs (e.g., including the UE 215) may be incapable of performing inter-frequency measurements based on LP-SSs (e.g., the LP-SS 230) due to an associated LP-WUR (e.g., the LP-WUR 217) failing to support RF retuning.

The UE 215 may determine to use both the LP-SSs 230 and the SSBs 235 for RRM measurements. In some examples, however, a received power metric obtained through measurement of the LP-SSs 230 via the LP-WUR 217 and a received power metric obtained through measurement of the SSBs 235 via the main radio 216 may be inconsistent. For example, the SSBs 235 and the LP-SSs 230 may be associated with (e.g., use) different waveforms or different bandwidths, or both. As such, measurements performed on the LP-SSs 230 using the LP-WUR 217 may scale differently from measurements performed on the SSBs 235 using the main radio 216. In other words, metrics obtained from the LP-WUR 217 on the LP-SSs 230 and measurements obtained from the main radio 216 on the SSBs 235 may be inconsistent. Inconsistent measurements across the LP-SSs 230 and the SSBs 235 may degrade a performance of cell selection (or cell reselection) at the UE 215. That is, failing to use a consistent metric to evaluate cell re-selection criteria and perform cell ranking may degrade a performance of wireless communications at the UE 215.

In some examples, one or more techniques for RRM measurements with LP-SSs, as described herein, may provide a framework for obtaining a consistent metric for cell reselection at the UE 215. For example, such techniques may provide a mapping (e.g., a linear mapping) between the LP-SS-based measurements and SSB-based measurements (e.g., equivalent SSB-based measurements). In other words, one or more techniques for RRM measurements with LP-SSs, as described herein, may establish (or enable the UE 215 to establish) a mapping between LP-SS-based measurements and SSB-based measurements.

As illustrated in the example of FIG. 2, the UE 215 may receive a resource indication 225 from the network entity 205-a (e.g., the serving cell) via the main radio 216. The resource indication 225 may indicate one or more resources (e.g., time-frequency resources) for reception of one or more of the LP-SSs 230 via the LP-WUR 217 (e.g., via a radio that may be associated with lower power consumption than the main radio 216). In some examples, the UE 215 may receive one or more of the LP-SSs 230 via the LP-WUR 217 over the one or more resources. For example, the UE 215 may receive an LP-SS 230-c from the network entity 205-a via the LP-WUR 217 in accordance with an idle mode of the UE 215 (e.g., while operating in the idle mode). In such examples, the UE 215 may perform a cell reselection in accordance with receiving the LP-SS 230-c while in the idle mode. That is, the UE 215 may associate with the network entity 205-a or the network entity 205-b in accordance with the cell reselection, which may be based on RRM measurements (e.g., received power measurements) performed on the LP-SS 230-c and, in some examples, an SSB 235-c. For example, the UE 215 may also receive the SSB 235-c from the network entity 205-b via the main radio 216. In some examples, the UE 215 may perform a received power measurement on the LP-SS 230-c while in the idle mode. In such examples, the UE 215 may obtain a metric (e.g., for cell reselection) based on the received power measurement of the LP-SS 230-c and a mapping between the LP-SS-based measurements and the SSB-based measurements (e.g., between received power measurements of the one or more of the LP-SSs 230 and received power measurements of the SSBs 235). For example, the UE 215 may apply an offset to the received power measurement of the LP-SS 230-c to obtain a metric that maps the received power measurement to a same scale as SSB-based measurements. In other words, the UE 215 may apply (e.g., add) the offset to LP-SS-based measurements to translate (e.g., map) the LP-SS-based measurements to a same scale as the SSB-based measurements.

In some examples, the network entity 205-a may configure the UE 215 (or the UE 215 may be otherwise configured) with an offset for mapping the LP-SS-based measurements to the SSB-based measurements. In some other examples, the UE 215 may determine the offset based on calibrations (e.g., periodic calibrations). That is, to map the LP-SS-based measurements to the SSB-based measurements, the UE 215 may use a configured (e.g., pre-defined) offset or derive an offset from periodic calibrations. In some examples, mapping LP-SS-based measurements to the SSB-based measurements may enable the UE 215 to compare measurements based on the LP-SSs 230 to measurements based on and the SSBs 235 (e.g., for cell ranking as part of cell resection). Additionally, by mapping LP-SS-based measurements to the SSB-based measurements, the UE 215 may implement a cell resection procedure that uses an SSB-based measurement framework (e.g., with no or relatively few changes). In other words, mapping LP-SS-based measurements to the SSB-based measurements may enable the UE 215 to use a framework for cell reselection that is common to (e.g., compatible with) LP-SS-based measurements and SSB-based measurements. In some examples, the mapping (or offset) may support (e.g., and be transparent to) one or more enhancements for RRM measurement procedures, among other benefits.

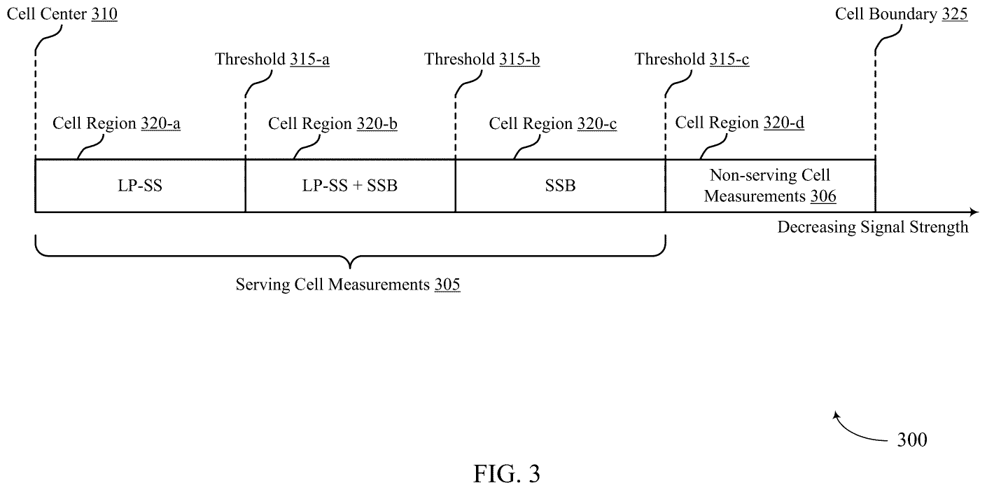

FIG. 3 shows an example of a cell region diagram 300 that supports RRM measurements with LP-SSs in accordance with one or more aspects of the present disclosure. The cell region diagram 300 may implement or be implemented at one or more aspects of the wireless communications system 100 and the wireless communications system 200. For example, the cell region diagram 300 may be implemented at a UE or one or more network entities, or any combination thereof, which may be examples of the corresponding devices illustrated by and described with reference to FIGS. 1 and 2. In the example of FIG. 3, the UE may be operating in an idle or inactive mode (e.g., an RRC idle mode or an RRC inactive mode). For example, the UE may establish a connection (e.g., an RRC connection) with a network entity via a cell, which may be referred to as a serving cell. In some examples, the UE may identify a lack of uplink data (or a lack of downlink data) to be communicated between the UE and the network entity and may enter an idle mode (or inactive mode). In some examples, such as while the UE is operating in the idle mode, the UE may perform RRM measurements on one or more types of reference signals (e.g., LP-SSs, SSBs) transmitted via the serving cell or via one or more non-serving cells (e.g., neighboring cells), or both. For example, the UE 215 may perform serving cell measurements 305 on one or more types of reference signals transmitted via the serving cell or non-serving cell measurements 306 on one or more types of reference signals transmitted via a non-serving cell, or both, while operating in the idle mode.

In some examples, the UE 215 may determine aspects of the serving cell measurements 305 or the non-serving cell measurements 306 (or both) based on one or more criteria. For example, in the idle or inactive mode, the UE 215 may offload one or more RRM measurements from a main radio at the UE to an LP-WUR at the UE. That is, the UE may perform RRM measurements using LP-SS. In some examples, the UE may use LP-SSs to perform RRM measurements on the serving cell. That is, the UE may perform the serving cell measurements 305 using LP-SS. In some examples, the UE may be configured with criteria for performing the serving cell measurements 305 using LP-SS. For example, the network entity may configure the UE with one or more criteria for performing (e.g., for determining whether, when, and how often to perform) the serving cell measurements 305 (or the non-serving cell measurements 306) on LP-SSs. That is, the network entity (e.g., a gNB) may control whether, when, and how often the UE may perform the serving cell measurements 305 based on LP-SSs. In some examples, the network entity may control whether, when, and how often the UE may perform the serving cell measurements 305 based on LP-SSs via criteria. For example, the network entity may indicate (e.g., advertise) one or more criteria for perform the serving cell measurements 305 on LP-SSs through system information. That is, the UE may receive system information from the network entity that indicates a criterion (or multiple criteria) for reception of the LP-SSs on a serving cell.

In some examples, the criteria may be based on a signal strength of SSBs transmitted via the serving cell. For example, the network entity providing the serving cell may be located relatively near to a center of the serving cell (e.g., at or relatively near to a cell center 310). As such, a signal strength of SSBs transmitted via the serving cell may be relatively high (e.g., strong) near the cell center 310 and relatively low near a cell boundary 325). In other words, as illustrated in the example of FIG. 3, a strength (e.g., a received power) of signals transmitted via the serving cell may decrease as the UE moves from the cell center 310 to the cell boundary 325. As such, the UE may determine that a location of the UE is relatively near to the cell center 310, for example, if a signal strength of SSBs transmitted via the serving cell is relatively high. Similar, the UE may determine that a location of the UE relatively far from the cell center 310 (or relatively near to the cell boundary 325), for example, if a signal strength of SSBs transmitted via the serving cell is relatively low. In other words, the UE may determine a location of the UE relative to the cell center 310 based on a signal strength of SSBs (or LP-Ss) transmitted via the serving cell. In some examples, a signal strength of LP-SSs transmitted via the serving cell may also be relatively high (e.g., strong) near the cell center 310 and relatively low near the cell boundary 325. In some examples, LP-SSs with relatively low signal strength (e.g., at relatively low RSRP) may not provide full coverage or may not provide relatively reliable measurements. As such, an accuracy of the serving cell measurements 305 on LP-SSs may be relatively high near the cell center 310 and relatively low near the cell boundary 325. Accordingly, the criteria may indicate that cell reselection using the serving cell measurements 305 on LP-SSs may be based on a location of the UE relative to the cell center 310. Additionally, or alternatively, the criteria may indicate that cell reselection using the serving cell measurements 305 on LP-SSs may be based on a mobility state of the UE. For example, the UE may be an example of a mobile device capable of moving (e.g., changing locations) relatively quickly. In such an example, the UE may perform cell reselection relatively frequently (e.g., may reselect cells relatively often to maintain a network connection) and power saving gains achieved through use of LP-SSs may be reduced. In other words, power savings from LP-SS-based measurement may be reduced (e.g., become marginal) if the UE has a relatively high mobility. As such, cell reselection using the serving cell measurements 305 on LP-SSs may be based on a signal strength of SSBs transmitted via the serving cell (e.g., a signal strength of serving cell SSBs), or a mobility state of the UE, or both. That is, the criteria for cell reselection based on the serving cell measurements 305 using LP-SSs may be based on a signal strength of SSBs transmitted via the serving cell, or a mobility state of the UE, or both. For example, the criteria may indicate that UEs located near the cell center 310 with a relatively low mobility may use LP-SS to perform RRM measurements.

In some examples, the UE 215 may determine aspects of the serving cell measurements 305 or the non-serving cell measurements 306 (or both) based on a location of the UE relative to the cell center 310. For example, the criteria may indicate for the UE to perform (e.g., and use for cell reselection) the serving cell measurements 305 on LP-SSs, LP-SS and SSBs, or SSBs based on whether the location of the UE is relatively close to the cell center 310 or the cell boundary 325 (e.g., cell edge). In other words, the criteria may indicate for the UE to perform cell reselection in accordance with the serving cell measurements 305 on LP-SSs, a mixture of LP-SSs and SSBs, or SSBs based on a location of the UE (e.g., based on which of the cell regions 320 is associated with a location of the UE).

As illustrated in the example of FIG. 3, the serving cell may be divided into multiple cell regions (e.g., the cell regions 320) in which the UE may perform multiple (e.g., different) types of measurements. For example, the UE may use LP-SS for the serving cell measurements 305 in a cell region 320-a, which may enable the UE to conserve an increased quantity of power. In such an example, as the UE moves away from the cell center 310 (e.g., into a cell region 320-b or a cell region 320-c) a signal strength of the LP-SS may be reduced and, as such, an accuracy of the serving cell measurements 305 performed using the LP-SS may be reduced. To increase an accuracy of the serving cell measurements 305, the UE may determine to perform the serving cell measurements on both LP-SS and SSBs in the cell region 320-b and perform the serving cell measurements on SSBs in the cell region 320-c. For example, the UE may identify a region of the serving cell associated with the location of the UE based on a signal strength of the LP-SSs received on the serving cell. In other words, the UE may identify which of the cell regions 320 the UE may be located in based on the signal strength (e.g., received power) of LP-SSs transmitted via the serving cell. In such examples, the UE may receive (e.g., monitor for and use for RRM measurements) LP-SSs based on the identified region. For example, the UE may receive LP-SS on the serving cell (e.g., and use the received LP-SSs for the serving cell measurements 305) based on a distance of the identified region from the cell center 310 satisfying a first threshold. In other words, the UE may receive LP-SS on the serving cell (e.g., and use the received LP-SSs for the serving cell measurements 305) based on a location of the UE being associated with the cell region 320-a or a cell region 320-b (e.g., cell regions whose distance from the cell center 310 satisfies the threshold). In other words, the UE may perform RRM measurements on LP-SSs based on a signal strength of LP-SS received on the serving cell or a signal strength of SSBs received on the serving cell (or both), which may be indicative of a region of the UE within the serving cell. For example, the UE may perform RRM measurements on LP-SS received on the serving cell based on a signal strength of LP-SS received on the serving cell satisfying a threshold 315-a.

In some examples, the UE may receive LP-SS and SSBs on the serving cell (e.g., and use the received LP-SSs and SSBs for the serving cell measurements 305) based on a distance of the identified region from the cell center 310 satisfying a first threshold and failing to satisfy a second threshold. That is, the UE may receive LP-SSs and SSBs on the serving cell (e.g., and use the received LP-SSs and SSBs for the serving cell measurements 305) based on a location of the UE being associated with the cell region 320-b. In other words, the UE may perform RRM measurements on LP-SS and SSBs received on the serving cell based on a signal strength of LP-SS received on the serving cell failing to satisfy the threshold 315-a and a signal strength of SSBs received on the serving cell satisfy the threshold 315-b.

In some examples, the UE may receive SSBs on the serving cell (e.g., and use the received SSBs for the serving cell measurements 305) based on a distance of the identified region from the cell center 310 satisfying a third threshold and failing to satisfy the second threshold. That is, the UE may receive SSBs on the serving cell (e.g., and use the received SSBs for the serving cell measurements 305) based on a location of the UE being associated with the cell region 320-c. In other words, the UE may perform RRM measurements on SSBs received on the serving cell based on a signal strength of SSBs received on the serving cell failing to satisfy the threshold 315-b and satisfying a threshold 315-c.

In some examples, the UE may determine to perform the non-serving cell measurements 306 (e.g., for cell reselection) based on a distance of the identified region from the cell center 310 failing to satisfy the third threshold. That is, the UE may receive LP-SS or SSBs (or both) on the non-serving cell (e.g., and use the received SSBs for the non-serving cell measurements 306) based on a location of the UE being associated with the cell region 320-d. In other words, the UE may perform RRM measurements on LP-SS or SSBs received on the non-serving cell based on a signal strength of SSBs received on the serving cell failing to satisfy the threshold 315-c.

In some examples, the UE may use one or more other thresholds (e.g., SIntraSearch and SnonIntraSearch) for the non-serving cell measurements 306 to determine whether to perform the non-serving cell measurements 306 (e.g., within the cell region 320-d). For example, the UE may use the one or more threshold and the serving cell measurements 305 to determine whether to perform the non-serving cell measurements 306.

In some examples, the UE may map LP-SS-based measurements to the same scale used at the UE for SSB-based measurements to evaluate the one or more other thresholds. For example, the UE may apply an offset to the serving cell measurements 305 on the LP-SSs or the non-serving cell measurements 306 on LP-SSs, such that the UE may compare LP-SS-based measurements and SSB-based measurements for cell reselection. In some examples, the offset may be an example of an offset as described with reference to FIG. 2.

In some examples, the UE may perform the non-serving cell measurements 306 on LP-SS (e.g., may perform neighbor cell measurements using LP-SS) based on one or more other criteria. That is, the UE may be configured with criteria for performing the non-serving cell measurements 306 using LP-SS. For example, the network entity may configure the UE with one or more criteria for performing (e.g., for determining whether, when, and how often to perform) the non-serving cell measurements 306 on LP-SSs. In other words, the network entity may provide criteria on whether the UE may perform LP-SS-based measurements on a neighbor cell. For example, the criteria may indicate, to the UE, to perform the non-serving cell measurements 306 on LP-SSs if a signal strength of SSBs transmitted via a non-serving cell satisfies (e.g., is above, exceeds) a threshold. In other words, the criteria may indicate, to the UE, to perform the non-serving cell measurements 306 on LP-SSs if a RSRP measurement of SSBs transmitted via a neighbor cell satisfies a threshold. Additionally, or alternatively, the criteria may indicate that non-serving cells (e.g., neighbor cells) with a relatively high priority frequency (e.g., a frequency with a higher priority than a priority of a frequency used for the serving cell) may be excluded from LP-SS measurements (e.g., to improve or maintain an accuracy of RRM measurements for non-serving cell with relatively high priority). In some examples, the UE may use a ranking formula for cell reselection. In such an example, the UE may rank the non-serving cells in accordance with the ranking formula and using a metric that may be common to the LP-SS-based measurements and SSB-based measurements. For example, the UE may map the LP-SS-based measurements to the same scale used by SSB-based measurements and then rank the non-serving cells based on the mapped measurements. In other words, a value of Qrxlevmeas or Qqualmeas may be based on a common metric (e.g., Qrxlevmeas or Qqualmeas in the Rs/n formula may be based on combined measurements).

In some examples, the network entity may indicate an availability or a location (or both) of LP-SS transmissions from one or more non-serving cell. That is, the serving cell may provide availability and location information of LP-SSs transmitted by non-serving cells (e.g., neighbor cells) to the UE. In some examples, the network entity may indicate the availability or location of LP-SS transmissions from the one or more network entities via system information (e.g., in a SIB, such as SIB3 or SIB4). In some examples, such as examples in which a location of LP-SSs may be determined with respect to SSBs (e.g., based on a pre-defined offset, such as an offset relative to a synchronization raster), the UE may determine an availability of LP-SS transmissions from one or more non-serving cell through SSBs transmitted via the one or more non-serving cells. In some examples, determining an availability of LP-SS transmissions from non-serving cells may improve a performance of RRM measurements using LP-SSs, among other benefits.

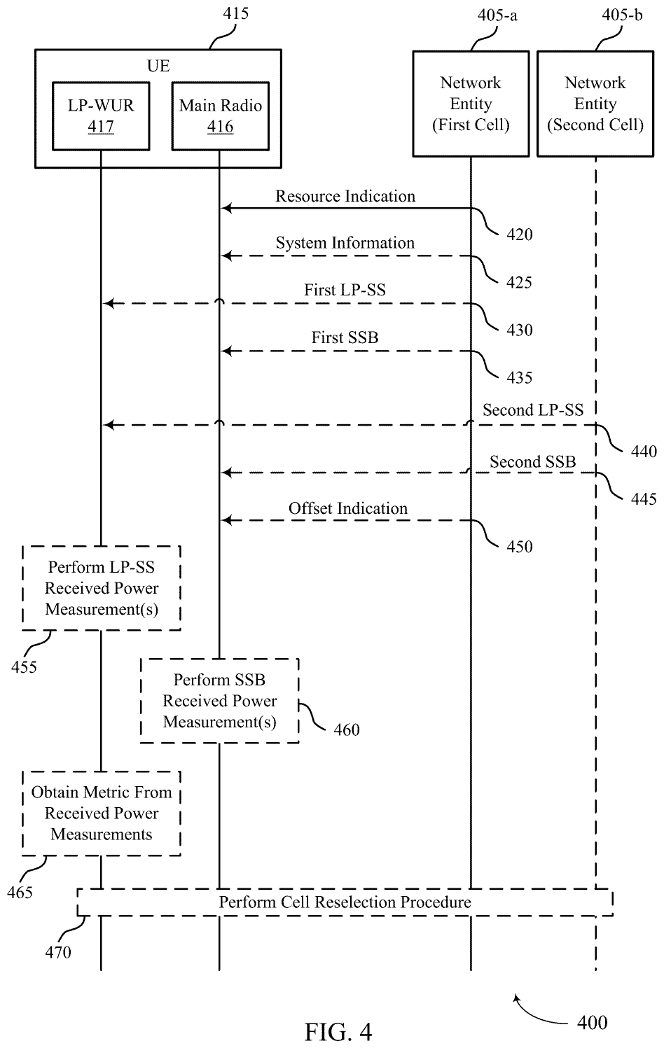

FIG. 4 shows an example of a process flow 400 that supports RRM measurements with LP-SSs in accordance with one or more aspects of the present disclosure. In some examples, the process flow 400 may implement one or more aspects of the wireless communications system 100, the wireless communications system 200, and the cell region diagram 300. For example, the process flow 400 may include example operations associated with a network entity 405-a, a network entity 405-b, and a UE 415, which may be examples of the corresponding devices illustrated by and described with reference to FIGS. 1 through 3. The operations performed by the network entity 405-a, the network entity 405-b, and the UE 415 may support improvements to communications between the UE 415 and the network entities 405, among other benefits. In the following description of the process flow 400, the operations between the UE 415 and the network entities 405 may occur in a different order than the example order shown. Additionally, or alternatively, the operations performed by the UE 415 and the network entities 405 may be performed in different orders or at different times. Some operations may also be omitted and some operations may be combined.

In the example of FIG. 4, the network entity 405-a may serve a first cell and the network entity 405-b may serve a second cell. That is, operations associated the network entity 405-a (e.g., transmissions from the network entity 405-a or receptions at the network entity 405-a) may occur via the first cell and operations associated the network entity 405-b (e.g., transmissions from the network entity 405-b or receptions at the network entity 405-b) may occur via the second cell. In the example of FIG. 4, the first cell may be an example of a serving cell and the second cell may be an example of a non-serving cell (e.g., a neighboring cell). That is, the network entity 405-a may be an example of a serving network entity and the network entity 405-b may be an example of a non-serving network entity (e.g., a neighboring network entity). Additionally, in the example of FIG. 4, the UE 415 may include an LP-WUR 417 and a main radio 416, in which the LP-WUR 417 may be associated with lower power consumption than the main radio 416.

At 420, the UE 415 may receive a resource indication from the network entity 405-a via the main radio 416. The resource indication may be an example of a resource indication illustrated by and described with reference to FIGS. 2 and 3. For example, the resource indication may indicate one or more resources for reception of one or more LP-SSs associated with the LP-WUR 417.

In some examples, at 425, the UE 415 may receive system information via the main radio 416. The system information may be an example of system information illustrated by and described with reference to FIGS. 2 and 3. For example, the system information may indicate a time and frequency location of resources for reception of LP-SSs on the first cell, or the second cell, or both. For example, the system information may be an example of RMSI illustrated by and described with reference to FIG. 3. In such an example, the one or more resources indicated via the resource indication received at 420 may be based on the time and frequency location indicated via the system information (e.g., via the RMSI). In some examples, the system information may further indicate an availability of the second cell (e.g., the non-serving cell) for reception of LP-SSs.

In some other examples, the system information received at 425 may indicate a time and frequency location of resources for reception of SSBs on the first cell, on the second cell, or both. In such examples, the UE 415 may identify the time and the frequency location of the LP-SSs based on the indicated time and frequency location of the SSB. Additionally, in such examples, the UE 415 may determine an availability of the second cell for reception of the one or more LP-SSs based on a received power of the SSBs.

In some examples, the system information received at 425 may indicate a first criterion for reception of one or more LP-SSs on the first cell (e.g., a serving cell). Additionally, or alternatively, the system information may indicate a second criterion for reception of one or more LP-SSs on the second cell (e.g., a non-serving cell). In some examples, the UE 415 may monitor for LP-SSs on the first cell serving cell based on the first criterion being satisfied. Additionally, or alternatively, the UE 415 may monitor for LP-SSs on the second cell based on the second criterion being satisfied. The first criterion and the second criterion may be examples of criteria as described with reference to FIGS. 2 and 3. For example, the first criterion and the second criterion may each correspond to a signal strength threshold, a signal quality threshold, a mobility state of the UE 415, a priority associated with the first cell, a priority associated with the second cell, or a threshold distance between a cell center and a region associated with a location of the UE, among other examples. In some examples, the UE 415 may receive one or more LP-SSs on the first cell or the second cell based on the monitoring.

For example, at 430, the UE 415 may receive a first LP-SS via the first cell based on monitoring the first cell (e.g., in response to the first criterion being satisfied). The first LP-SS may be an example of an LP-SS illustrated by and described with reference to FIGS. 2 and 3. For example, the first LP-SS may be detectable at the UE 415 via the LP-WUR 417.

Additionally, at 440, the UE 415 may receive a second LP-SS via the second cell based on monitoring the second cell (e.g., in response to the second criterion being satisfied). The second LP-SS may be an example of an LP-SS illustrated by and described with reference to FIGS. 2 and 3. For example, the second LP-SS may be detectable at the UE 415 via the LP-WUR 417.

In some examples, at 455, the UE 415 may perform received power measurements on the first LP-SS and the second LP-SS while in the idle mode. The received power measurements may be examples of RRM measurements as described with reference to FIGS. 2 and 3. For example, the UE may perform cell reselection based on the received power measurements on the first LP-SS, or the second LP-SS, or both.

In some examples, at 435, the UE 415 may receive a first SSB via the first cell based on monitoring the first cell. The first SSB may be an example of an SSB illustrated by and described with reference to FIGS. 2 and 3. For example, the first SSB may be detectable at the UE 415 via the main radio 416.

Additionally, at 445, the UE 415 may receive a second SSB via the second cell based on monitoring the second cell. The second SSB may be an example of an SSB illustrated by and described with reference to FIGS. 2 and 3. For example, the second SSB may be detectable at the UE 415 via the main radio 416.

In some examples, at 460, the UE 415 may perform received power measurements on the first SSB and the second SSB while in the idle mode. The received power measurements may be examples of RRM measurements as described with reference to FIGS. 2 and 3. For example, the UE may perform cell reselection based on the received power measurements on the first SSB, or the second SSB, or both.

In some examples, at 465, the UE 415 may obtain a metric based on the received power measurements performed on the first LP-SS or the second LP-SS (or both) and a mapping between the received power measurements performed on the first LP-SS or the second LP-SS (or both) and the received power measurements performed on the first SSB or the second SSB (or both). The metric may be an example of a metric as described with reference to FIGS. 2 and 3. For example, the metric may enable the UE to compare the LP-SS-based measurements to the SSB-based measurements for cell reselection. In some examples, the mapping may be an example of a mapping as described with reference to FIG. 2. For example, the mapping may be based on an offset or calibration measurements.

In some examples, at 450, the UE 415 may receive an offset indication via the main radio 416. The offset indication may indicate an offset between the received power measurements of the first LP-SS or the second LP-SS (or both) and the received power measurements of the first SSB or the second SSB (or both). In such an example, the mapping may be based on the offset. In some other examples, the UE 415 may perform a first calibration measurement on the first SSB or the second SSB (or both) and a second calibration measurement on the first LP-SS or the second LP-SS (or both). In such an example, the mapping may be based on a difference between the first calibration measurement and the second calibration measurement.

In some examples, at 470, the UE 415 may perform a cell reselection in accordance with receiving the first LP-SS or the second LP-SS (or both) while in the idle mode. The cell reselection procedure may be an example of a cell reselection procedure as described with reference to FIGS. 2 and 3. For example, the UE may associate with the network entity 405-a (e.g., via the first cell) or the network entity 405-b (e.g., via the second cell) in accordance with the cell reselection. In some examples, performing the cell reselection in accordance with receiving the first LP-SS or the second LP-SS (or both) while in the idle mode may lead to reduced power consumption at the UE 415, among other benefits.

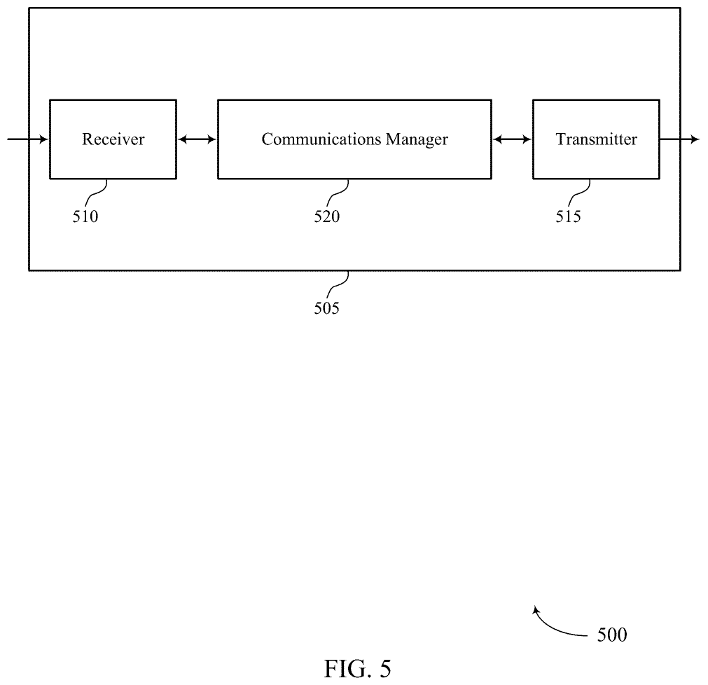

FIG. 5 shows a block diagram 500 of a device 505 that supports RRM measurements with LP-SSs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to RRM measurements with LP-SSs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to RRM measurements with LP-SSs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of RRM measurements with LP-SSs as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, in some examples, the communications manager 520, the receiver 510, the transmitter 515, or various combinations or components thereof may be implemented in hardware, software (e.g., executed by a processor), or any combination thereof. If implemented in code executed by a processor, the functions of the communications manager 520, the receiver 510, the transmitter 515, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE (e.g., the device 505) in accordance with examples as disclosed herein. For example, the communications manager 520 is capable of, configured to, or operable to support a means for receiving, via a first radio of the UE, an indication of one or more resources for reception of LP-SSs associated with a second radio of the UE, where the second radio is associated with lower power consumption than the first radio. The communications manager 520 is capable of, configured to, or operable to support a means for receiving, via the second radio, one or more LP-SSs over the one or more resources in accordance with an idle mode of the UE. The communications manager 520 is capable of, configured to, or operable to support a means for performing a cell reselection in accordance with receiving the one or more LP-SSs while in the idle mode, where an association between the UE and one or more network entities is based at least in part on the cell reselection in accordance with receiving the one or more low-power synchronization signals.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced power consumption.

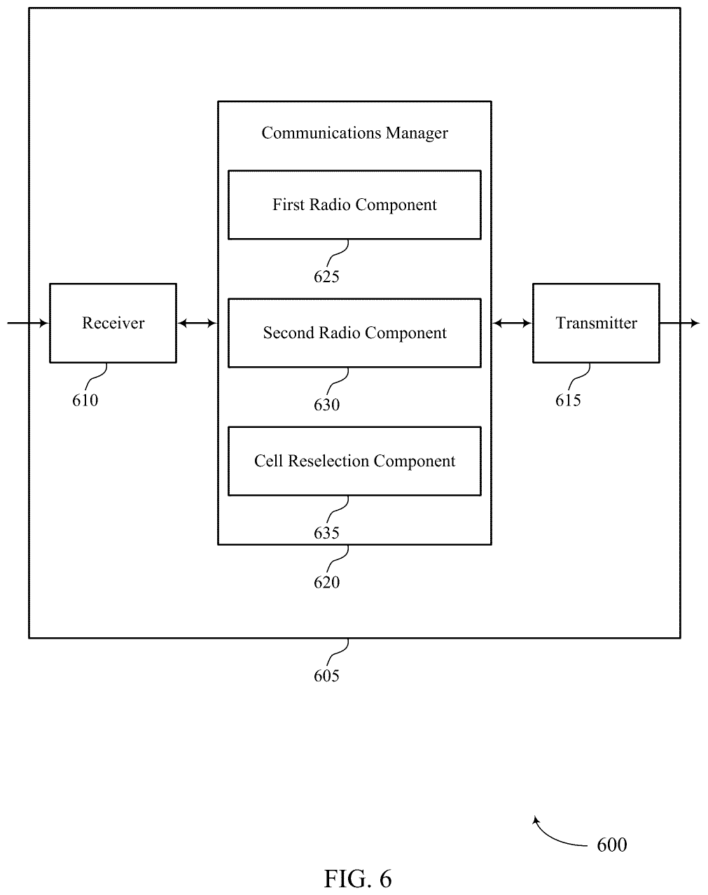

FIG. 6 shows a block diagram 600 of a device 605 that supports RRM measurements with LP-SSs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to RRM measurements with LP-SSs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RRM measurements with LP-SSs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of RRM measurements with LP-SSs as described herein. For example, the communications manager 620 may include a first radio component 625, a second radio component 630, a cell reselection component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE (e.g., the device 605) in accordance with examples as disclosed herein. The first radio component 625 is capable of, configured to, or operable to support a means for receiving, via a first radio of the UE, an indication of one or more resources for reception of LP-SSs associated with a second radio of the UE, where the second radio is associated with lower power consumption than the first radio. The second radio component 630 is capable of, configured to, or operable to support a means for receiving, via the second radio, one or more LP-SSs over the one or more resources in accordance with an idle mode of the UE. The cell reselection component 635 is capable of, configured to, or operable to support a means for performing a cell reselection in accordance with receiving the one or more LP-SSs while in the idle mode, where an association between the UE and one or more network entities is based at least in part on the cell reselection in accordance with receiving the one or more low-power synchronization signals.

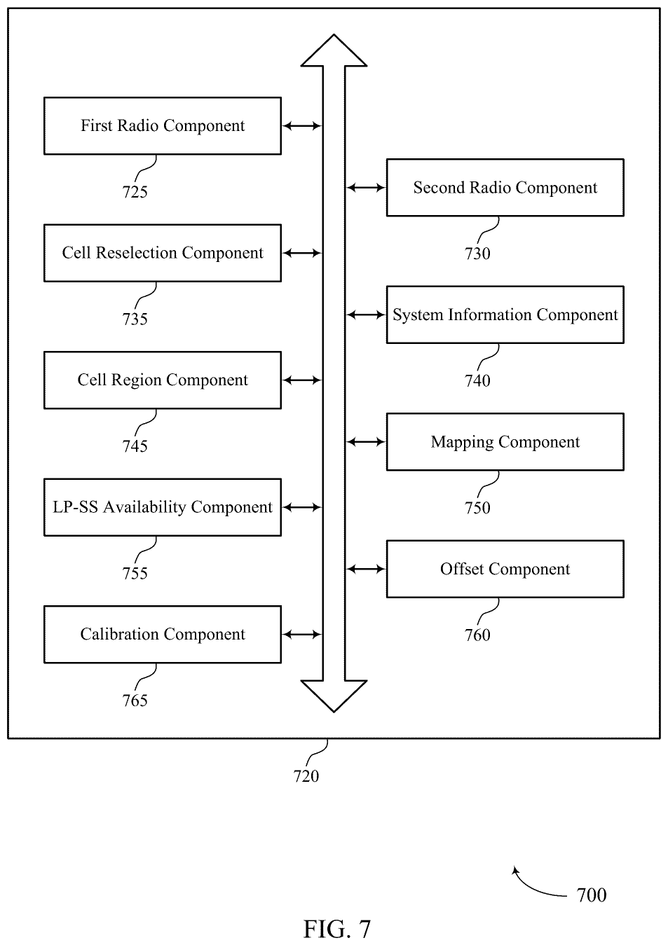

FIG. 7 shows a block diagram 700 of a communications manager 720 that supports RRM measurements with LP-SSs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of RRM measurements with LP-SSs as described herein. For example, the communications manager 720 may include a first radio component 725, a second radio component 730, a cell reselection component 735, a system information component 740, a cell region component 745, a mapping component 750, an LP-SS availability component 755, an offset component 760, a calibration component 765, or any combination thereof. Each of these components, or subcomponents thereof (e.g., one or more processors, one or more memories), may communicate, directly or indirectly, with one another (e.g., via one or more buses).

The communications manager 720 may support wireless communications at a UE in accordance with examples as disclosed herein. The first radio component 725 is capable of, configured to, or operable to support a means for receiving, via a first radio of the UE, an indication of one or more resources for reception of LP-SSs associated with a second radio of the UE, where the second radio is associated with lower power consumption than the first radio. The second radio component 730 is capable of, configured to, or operable to support a means for receiving, via the second radio, one or more LP-SSs over the one or more resources in accordance with an idle mode of the UE. The cell reselection component 735 is capable of, configured to, or operable to support a means for performing a cell reselection in accordance with receiving the one or more LP-SSs while in the idle mode, where an association between the UE and one or more network entities is based at least in part on the cell reselection in accordance with receiving the one or more low-power synchronization signals.

In some examples, the second radio component 730 is capable of, configured to, or operable to support a means for performing a received power measurement on a LP-SS of the one or more LP-SSs while in the idle mode, where performing the cell reselection is based on the received power measurement.

In some examples, the mapping component 750 is capable of, configured to, or operable to support a means for obtaining a metric based on the received power measurement and a mapping between received power measurements of the one or more LP-SSs and received power measurements of SSBs, where performing the cell reselection is based on the metric.

In some examples, the offset component 760 is capable of, configured to, or operable to support a means for receiving, via the first radio, an indication of an offset between the received power measurements of the one or more LP-SSs and the received power measurements of SSBs, where the mapping is based on the offset.

In some examples, the first radio component 725 is capable of, configured to, or operable to support a means for receiving, via the first radio, one or more SSBs. In some examples, the calibration component 765 is capable of, configured to, or operable to support a means for performing a first calibration measurement on the one or more SSBs and a second calibration measurement on the one or more LP-SSs, where the mapping is based on a difference between the first calibration measurement and the second calibration measurement.

In some examples, the system information component 740 is capable of, configured to, or operable to support a means for receiving, via the first radio, system information that indicates a criterion for reception of the one or more LP-SSs received on a serving cell. In some examples, the second radio component 730 is capable of, configured to, or operable to support a means for monitoring for the one or more LP-SSs on the serving cell based on the criterion being satisfied, where receiving the one or more LP-SSs is based on the monitoring. In some examples, the criterion corresponds to a threshold signal strength of SSBs received on the serving cell, or a mobility state of the UE, or both.

In some examples, the cell region component 745 is capable of, configured to, or operable to support a means for determining whether to perform measurements on LP-SSs or SSBs received on a serving cell based on a signal strength of the one or more LP-SSs or a signal strength of one or more SSBs, or both.

In some examples, to support receiving the one or more LP-SSs, the second radio component 730 is capable of, configured to, or operable to support a means for performing received power measurements on the LP-SSs based on the signal strength of the one or more LP-SSs satisfying a first threshold.

In some examples, the first radio component 725 is capable of, configured to, or operable to support a means for performing received power measurements on the LP-SSs and the SSBs based on the signal strength of the one or more LP-SSs failing to satisfy a first threshold and the signal strength of the one or more SSBs satisfying a second threshold.

In some examples, to support receiving the one or more LP-SSs, the second radio component 730 is capable of, configured to, or operable to support a means for performing received power measurements on the SSBs based on the signal strength of the one or more SSBs failing to satisfy a third threshold.

In some examples, to support receiving the indication of the one or more resources, the second radio component 730 is capable of, configured to, or operable to support a means for receiving, on a serving cell, system information that indicates a time and frequency location of resources for reception of LP-SSs on the serving cell, or a non-serving cell, or both, where the one or more resources are based on the time and frequency location. In some examples, the system information further indicates an availability of the non-serving cell for reception of the one or more LP-SSs.

In some examples, to support receiving the indication of the one or more resources, the system information component 740 is capable of, configured to, or operable to support a means for receiving, on a serving cell, system information that indicates a time and frequency location of resources for reception of SSBs on the serving cell, or a non-serving cell, or both, where the one or more resources are based on the time and frequency location.

In some examples, the system information component 740 is capable of, configured to, or operable to support a means for receiving, via the first radio, a SSB on the non-serving cell based on the system information. In some examples, the LP-SS availability component 755 is capable of, configured to, or operable to support a means for determining an availability of the non-serving cell for reception of the one or more LP-SSs based on a received power of the SSB, where receiving the one or more LP-SSs is based on the availability.

In some examples, the system information component 740 is capable of, configured to, or operable to support a means for receiving, via the first radio, system information that indicates a criterion for reception of the one or more LP-SSs received on a non-serving cell. In some examples, the second radio component 730 is capable of, configured to, or operable to support a means for monitoring for the one or more LP-SSs on the non-serving cell based on the criterion being satisfied, where receiving the one or more LP-SSs is based on the monitoring. In some examples, the criterion corresponds to a threshold signal strength of SSBs received on the non-serving cell, or a priority associated with the non-serving cell, or both.

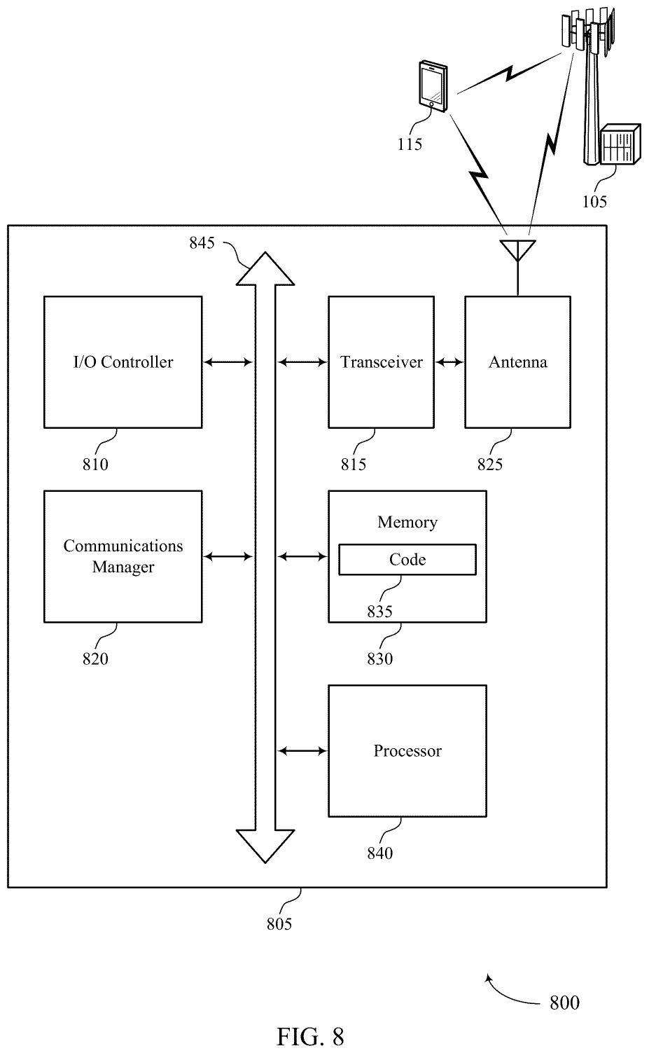

FIG. 8 shows a diagram of a system 800 including a device 805 that supports RRM measurements with LP-SSs in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a GPU, an NPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting RRM measurements with LP-SSs). For example, the device 805 or a component of the device 805 may include a processor 840 and memory 830 coupled with or to the processor 840, the processor 840 and memory 830 configured to perform various functions described herein.

The communications manager 820 may support wireless communications at a UE (e.g., the device 805) in accordance with examples as disclosed herein. For example, the communications manager 820 is capable of, configured to, or operable to support a means for receiving, via a first radio of the UE, an indication of one or more resources for reception of LP-SSs associated with a second radio of the UE, where the second radio is associated with lower power consumption than the first radio. The communications manager 820 is capable of, configured to, or operable to support a means for receiving, via the second radio, one or more LP-SSs over the one or more resources in accordance with an idle mode of the UE. The communications manager 820 is capable of, configured to, or operable to support a means for performing a cell reselection in accordance with receiving the one or more LP-SSs while in the idle mode, where an association between the UE and one or more network entities is based at least in part on the cell reselection in accordance with receiving the one or more low-power synchronization signals.

By including or configuring the communications manager 820 in accordance with examples as described herein, the device 805 may support techniques for improved communication reliability, reduced power consumption, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of RRM measurements with LP-SSs as described herein, or the processor 840 and the memory 830 may be otherwise configured to perform or support such operations.

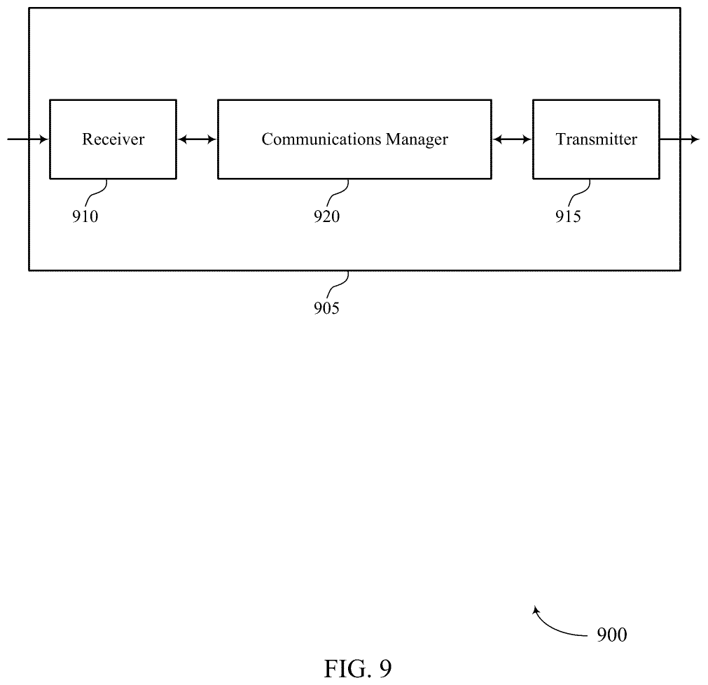

FIG. 9 shows a block diagram 900 of a device 905 that supports RRM measurements with LP-SSs in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of RRM measurements with LP-SSs as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, a GPU, an NPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory). Additionally, or alternatively, in some examples, the communications manager 920, the receiver 910, the transmitter 915, or various combinations or components thereof may be implemented in hardware, software (e.g., executed by a processor), or any combination thereof. If implemented in code executed by a processor, the functions of the communications manager 920, the receiver 910, the transmitter 915, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity (e.g., the device 905) in accordance with examples as disclosed herein. For example, the communications manager 920 is capable of, configured to, or operable to support a means for outputting an indication of one or more resources for reception of LP-SSs associated with a first radio of a UE, where the first radio is associated with lower power consumption than a second radio of the UE. The communications manager 920 is capable of, configured to, or operable to support a means for outputting one or more LP-SSs over the one or more resources in accordance with an idle mode of the UE, where an association between the network entity and the UE is based on a cell reselection in accordance with the one or more LP-SSs.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced power consumption.

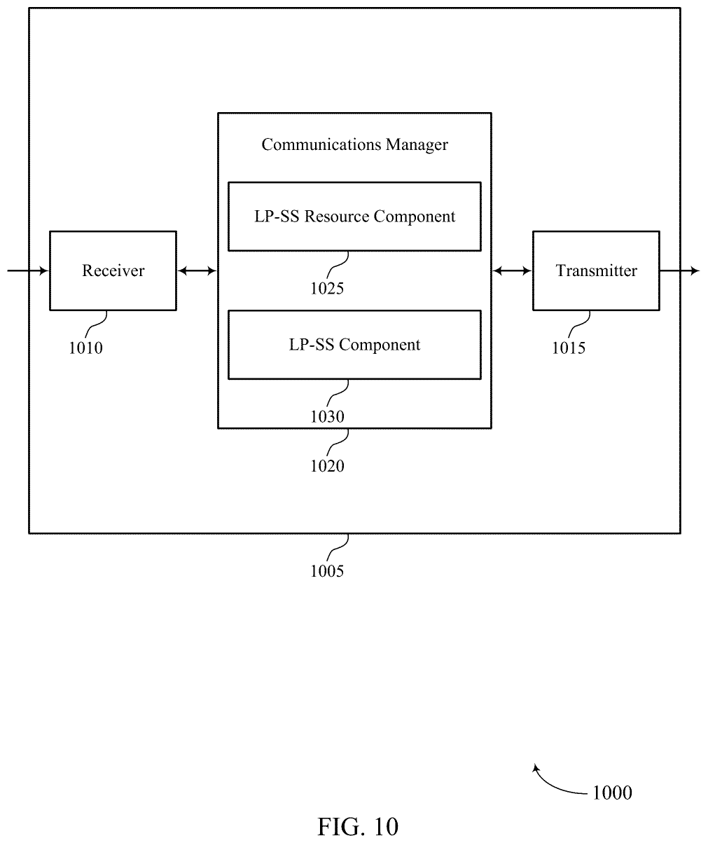

FIG. 10 shows a block diagram 1000 of a device 1005 that supports RRM measurements with LP-SSs in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of RRM measurements with LP-SSs as described herein. For example, the communications manager 1020 may include an LP-SS resource component 1025 an LP-SS component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity (e.g., the device 1005) in accordance with examples as disclosed herein. The LP-SS resource component 1025 is capable of, configured to, or operable to support a means for outputting an indication of one or more resources for reception of LP-SSs associated with a first radio of a UE, where the first radio is associated with lower power consumption than a second radio of the UE. The LP-SS component 1030 is capable of, configured to, or operable to support a means for outputting one or more LP-SSs over the one or more resources in accordance with an idle mode of the UE, where an association between the network entity and the UE is based on a cell reselection in accordance with the one or more LP-SSs.

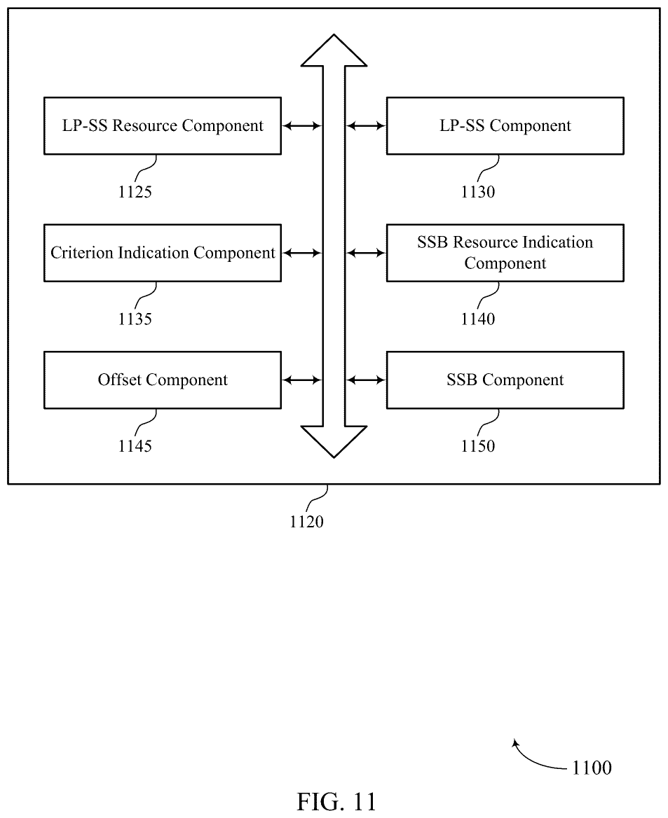

FIG. 11 shows a block diagram 1100 of a communications manager 1120 that supports RRM measurements with LP-SSs in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of RRM measurements with LP-SSs as described herein. For example, the communications manager 1120 may include an LP-SS resource component 1125, an LP-SS component 1130, a criterion indication component 1135, an SSB resource indication component 1140, an offset component 1145, an SSB component 1150, or any combination thereof. Each of these components, or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The LP-SS resource component 1125 is capable of, configured to, or operable to support a means for outputting an indication of one or more resources for reception of LP-SSs associated with a first radio of a UE, where the first radio is associated with lower power consumption than a second radio of the UE. The LP-SS component 1130 is capable of, configured to, or operable to support a means for outputting one or more LP-SSs over the one or more resources in accordance with an idle mode of the UE, where an association between the network entity and the UE is based on a cell reselection in accordance with the one or more LP-SSs.

In some examples, the cell reselection is based on a received power measurement of the one or more LP-SSs and a mapping between received power measurements of the one or more LP-SSs and received power measurements of SSBs.

In some examples, the offset component 1145 is capable of, configured to, or operable to support a means for outputting an indication of an offset between the received power measurements of the one or more LP-SSs and the received power measurements of SSBs, where the mapping is based on the offset.

In some examples, the SSB component 1150 is capable of, configured to, or operable to support a means for outputting one or more SSBs, where the mapping is based on a difference between a first calibration measurement on the one or more LP-SSs and a second calibration measurement on the one or more SSBs.

In some examples, the criterion indication component 1135 is capable of, configured to, or operable to support a means for outputting, on a serving cell, system information that indicates a criterion for reception of the one or more LP-SSs received on the serving cell, where the cell reselection is based on the criterion. In some examples, the criterion corresponds to a threshold signal strength of SSBs output on the serving cell, or a mobility state of the UE, or both.

In some examples, the cell reselection is based on a signal strength of the one or more LP-SSs or a signal strength of one or more SSBs, or both.

In some examples, the cell reselection is in accordance with received power measurements of LP-SSs based on the signal strength of the one or more LP-SSs satisfying a first threshold.

In some examples, the cell reselection is in accordance with received power measurements of LP-SSs and SSBs based on the signal strength of the one or more LP-SSs failing to satisfy a first threshold and the signal strength of one or more SSBs satisfying a second threshold.

In some examples, to support outputting the indication of the one or more resources, the LP-SS resource component 1125 is capable of, configured to, or operable to support a means for outputting, on a serving cell, system information that indicates a time and frequency location of resources for reception of LP-SSs on the serving cell, or a non-serving cell, or both, where the one or more resources are based on the time and frequency location. In some examples, the system information further indicates an availability of the non-serving cell for reception of the one or more LP-SSs.

In some examples, to support outputting the indication of the one or more resources, the SSB resource indication component 1140 is capable of, configured to, or operable to support a means for outputting, on a serving cell, system information that indicates a time and frequency location of resources for reception of SSBs on the serving cell, or a non-serving cell, or both, where the one or more resources are based on the time and frequency location.

In some examples, the criterion indication component 1135 is capable of, configured to, or operable to support a means for outputting, on a serving cell, system information that indicates a criterion for reception of the one or more LP-SSs on a non-serving cell, where the cell reselection is based on the criterion. In some examples, the criterion corresponds to a threshold signal strength of SSBs received on the non-serving cell, or a priority associated with the non-serving cell, or both.

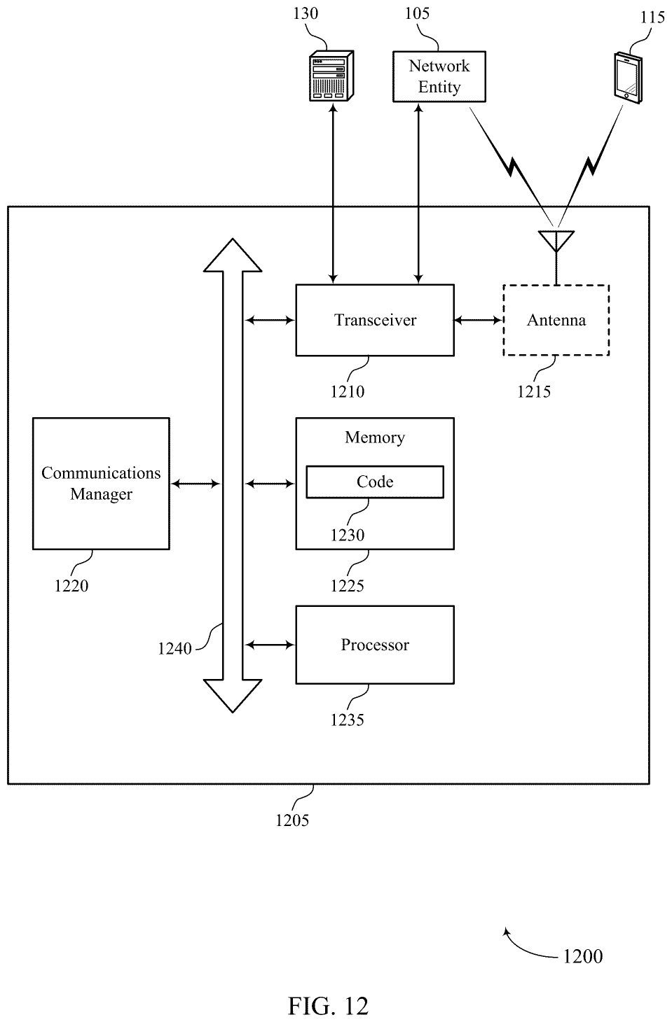

FIG. 12 shows a diagram of a system 1200 including a device 1205 that supports RRM measurements with LP-SSs in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, a GPU, an NPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting RRM measurements with LP-SSs). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity (e.g., the device 1205) in accordance with examples as disclosed herein. For example, the communications manager 1220 is capable of, configured to, or operable to support a means for outputting an indication of one or more resources for reception of LP-SSs associated with a first radio of a UE, where the first radio is associated with lower power consumption than a second radio of the UE. The communications manager 1220 is capable of, configured to, or operable to support a means for outputting one or more LP-SSs over the one or more resources in accordance with an idle mode of the UE, where an association between the network entity and the UE is based on a cell reselection in accordance with the one or more LP-SSs.

By including or configuring the communications manager 1220 in accordance with examples as described herein, the device 1205 may support techniques for improved communication reliability, reduced power consumption, and longer battery life.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of RRM measurements with LP-SSs as described herein, or the processor 1235 and the memory 1225 may be otherwise configured to perform or support such operations.

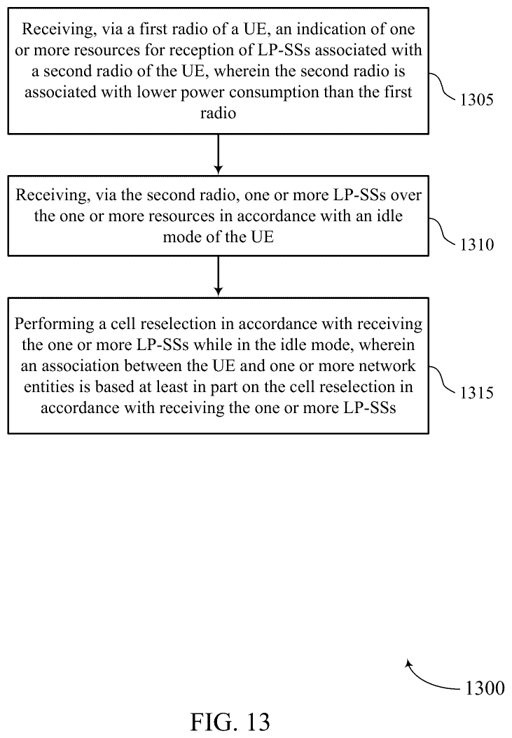

FIG. 13 shows a flowchart illustrating a method 1300 that supports RRM measurements with LP-SSs in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. additionally, or alternatively, the UE may perform aspects of the described functions using special-purpose hardware.

At 1305, the method may include receiving, via a first radio of the UE, an indication of one or more resources for reception of LP-SSs associated with a second radio of the UE, wherein the second radio is associated with lower power consumption than the first radio. The operations of 1305 may be performed in accordance with examples as disclosed herein. In some examples, aspects of the operations of 1305 may be performed by a first radio component 725 as described with reference to FIG. 7.

At 1310, the method may include receiving, via the second radio, one or more LP-SSs over the one or more resources in accordance with an idle mode of the UE. The operations of 1310 may be performed in accordance with examples as disclosed herein. In some examples, aspects of the operations of 1310 may be performed by a second radio component 730 as described with reference to FIG. 7.

At 1315, the method may include performing a cell reselection in accordance with receiving the one or more LP-SSs while in the idle mode, wherein an association between the UE and one or more network entities is based at least in part on the cell reselection in accordance with receiving the one or more low-power synchronization signals. The operations of 1315 may be performed in accordance with examples as disclosed herein. In some examples, aspects of the operations of 1315 may be performed by a cell reselection component 735 as described with reference to FIG. 7.

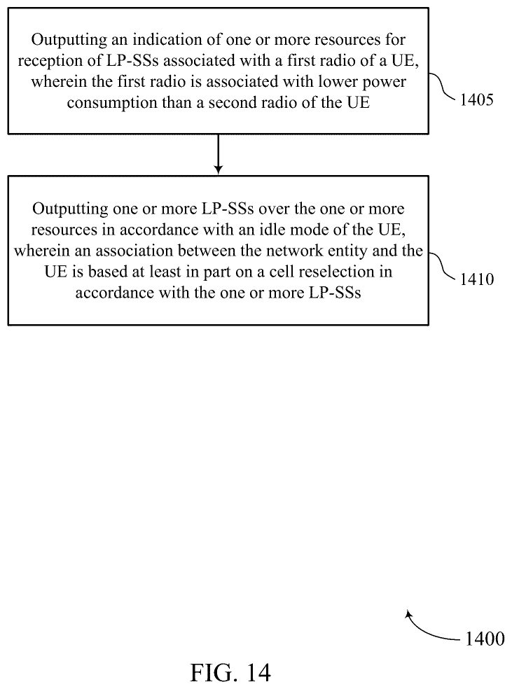

FIG. 14 shows a flowchart illustrating a method 1400 that supports RRM measurements with LP-SSs in accordance with aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting an indication of one or more resources for reception of LP-SSs associated with a first radio of a UE, wherein the first radio is associated with lower power consumption than a second radio of the UE. The operations of 1405 may be performed in accordance with examples as disclosed herein. In some examples, aspects of the operations of 1405 may be performed by an LP-SS resource component 1125 as described with reference to FIG. 11.

At 1410, the method may include outputting one or more LP-SSs over the one or more resources in accordance with an idle mode of the UE, wherein an association between the network entity and the UE is based at least in part on a cell reselection in accordance with the one or more LP-SSs. The operations of 1410 may be performed in accordance with examples as disclosed herein. In some examples, aspects of the operations of 1410 may be performed by an LP-SS component 1130 as described with reference to FIG. 11.

The following provides an overview of aspects of the present disclosure:

Aspect 1: A method for wireless communications at a UE, comprising: receiving, via a first radio of the UE, an indication of one or more resources for reception of LP-SSs associated with a second radio of the UE, wherein the second radio is associated with lower power consumption than the first radio; receiving, via the second radio, one or more LP-SSs over the one or more resources in accordance with an idle mode of the UE; and performing a cell reselection in accordance with receiving the one or more LP-SSs while in the idle mode, wherein an association between the UE and one or more network entities is based at least in part on the cell reselection in accordance with receiving the one or more low-power synchronization signals.

Aspect 2: The method of aspect 1, further comprising: performing a received power measurement on a LP-SS of the one or more LP-SSs while in the idle mode, wherein performing the cell reselection is based at least in part on the received power measurement.

Aspect 3: The method of aspect 2, further comprising: obtaining a metric based at least in part on the received power measurement and a mapping between received power measurements of the one or more LP-SSs and received power measurements of SSBs, wherein performing the cell reselection is based at least in part on the metric.

Aspect 4: The method of aspect 3, further comprising: receiving, via the first radio, an indication of an offset between the received power measurements of the one or more LP-SSs and the received power measurements of SSBs, wherein the mapping is based at least in part on the offset.

Aspect 5: The method of aspect 3, further comprising: receiving, via the first radio, one or more SSBs; and performing a first calibration measurement on the one or more SSBs and a second calibration measurement on the one or more LP-SSs, wherein the mapping is based at least in part on a difference between the first calibration measurement and the second calibration measurement.

Aspect 6: The method of any of aspects 1 through 5, further comprising: receiving, via the first radio, system information that indicates a criterion for reception of the one or more LP-SSs received on a serving cell; and monitoring for the one or more LP-SSs on the serving cell based at least in part on the criterion being satisfied, wherein receiving the one or more LP-SSs is based at least in part on the monitoring.

Aspect 7: The method of aspect 6, wherein the criterion corresponds to a threshold signal strength of SSBs received on the serving cell, or a mobility state of the UE, or both.

Aspect 8: The method of any of aspects 1 through 7, further comprising: determining whether to perform measurements on LP-SSs or SSBs received on a serving cell based at least in part on a signal strength of the one or more LP-SSs or a signal strength of one or more SSBs, or both.

Aspect 9: The method of aspect 8, further comprising: performing received power measurements on the LP-SSs based at least in part on the signal strength of the one or more low power synchronization signals satisfying a first threshold.

Aspect 10: The method of aspect 8, further comprising: performing received power measurements on the LP-SSs and the SSBs based at least in part on the signal strength of the one or more low power synchronization signals failing to satisfy a first threshold and the signal strength of the one or more SSBs satisfying a second threshold.

Aspect 11: The method of aspect 8, further comprising: perform received power measurements on the SSBs based at least in part on the signal strength of the one or more SSBs failing to satisfy a third threshold.

Aspect 12: The method of any of aspects 1 through 11, wherein receiving the indication of the one or more resources comprises: receiving, on a serving cell, system information that indicates a time and frequency location of resources for reception of LP-SSs on the serving cell, or a non-serving cell, or both, wherein the one or more resources are based at least in part on the time and frequency location.

Aspect 13: The method of aspect 12, wherein the system information further indicates an availability of the non-serving cell for reception of the one or more LP-SSs.

Aspect 14: The method of any of aspects 1 through 11, wherein receiving the indication of the one or more resources comprises: receiving, on a serving cell, system information that indicates a time and frequency location of resources for reception of SSBs on the serving cell, or a non-serving cell, or both, wherein the one or more resources are based at least in part on the time and frequency location.

Aspect 15: The method of aspect 14, further comprising: receiving, via the first radio, a SSB on the non-serving cell based at least in part on the system information; and determining an availability of the non-serving cell for reception of the one or more LP-SSs based at least in part on a received power of the SSB, wherein receiving the one or more LP-SSs is based at least in part on the availability.

Aspect 16: The method of any of aspects 1 through 15, further comprising: receiving, via the first radio, system information that indicates a criterion for reception of the one or more LP-SSs received on a non-serving cell; and monitoring for the one or more LP-SSs on the non-serving cell based at least in part on the criterion being satisfied, wherein receiving the one or more LP-SSs is based at least in part on the monitoring.

Aspect 17: The method of aspect 16, wherein the criterion corresponds to a threshold signal strength of SSBs received on the non-serving cell, or a priority associated with the non-serving cell, or both.

Aspect 18: A method for wireless communications at a network entity, comprising: outputting an indication of one or more resources for reception of LP-SSs associated with a first radio of a UE, wherein the first radio is associated with lower power consumption than a second radio of the UE; and outputting one or more LP-SSs over the one or more resources in accordance with an idle mode of the UE, wherein an association between the network entity and the UE is based at least in part on a cell reselection in accordance with the one or more LP-SSs.

Aspect 19: The method of aspect 18, wherein the cell reselection is based at least in part on a received power measurement of the one or more LP-SSs and a mapping between received power measurements of the one or more LP-SSs and received power measurements of SSBs.

Aspect 20: The method of aspect 19, further comprising: outputting an indication of an offset between the received power measurements of the one or more LP-SSs and the received power measurements of SSBs, wherein the mapping is based at least in part on the offset.

Aspect 21: The method of aspect 19, further comprising: outputting one or more SSBs, wherein the mapping is based at least in part on a difference between a first calibration measurement on the one or more LP-SSs and a second calibration measurement on the one or more SSBs.

Aspect 22: The method of any of aspects 18 through 21, further comprising: outputting, on a serving cell, system information that indicates a criterion for reception of the one or more LP-SSs received on the serving cell, wherein the cell reselection is based at least in part on the criterion.

Aspect 23: The method of aspect 22, wherein the criterion corresponds to a threshold signal strength of SSBs output on the serving cell, or a mobility state of the UE, or both.

Aspect 24: The method of any of aspects 18 through 23, wherein the cell reselection is based at least in part on a signal strength of the one or more LP-SSs or a signal strength of one or more SSBs, or both.

Aspect 25: The method of aspect 24, wherein the cell reselection is in accordance with received power measurements of LP-SSs based at least in part on the signal strength of the one or more low power synchronization signals satisfying a first threshold.

Aspect 26: The method of aspect 24, wherein the cell reselection is in accordance with received power measurements of LP-SSs and SSBs based at least in part on the signal strength of the one or more low power synchronization signals failing to satisfy a first threshold and the signal strength of one or more SSBs satisfying a second threshold.

Aspect 27: The method of any of aspects 18 through 26, wherein outputting the indication of the one or more resources comprises: outputting, on a serving cell, system information that indicates a time and frequency location of resources for reception of LP-SSs on the serving cell, or a non-serving cell, or both, wherein the one or more resources are based at least in part on the time and frequency location.

Aspect 28: The method of aspect 27, wherein the system information further indicates an availability of the non-serving cell for reception of the one or more LP-SSs.

Aspect 29: The method of any of aspects 18 through 26, wherein outputting the indication of the one or more resources comprises: outputting, on a serving cell, system information that indicates a time and frequency location of resources for reception of SSBs on the serving cell, or a non-serving cell, or both, wherein the one or more resources are based at least in part on the time and frequency location.

Aspect 30: The method of any of aspects 18 through 29, further comprising: outputting, on a serving cell, system information that indicates a criterion for reception of the one or more LP-SSs on a non-serving cell, wherein the cell reselection is based at least in part on the criterion.

Aspect 31: The method of aspect 30, wherein the criterion corresponds to a threshold signal strength of SSBs received on the non-serving cell, or a priority associated with the non-serving cell, or both.

Aspect 32: A UE for wireless communications, comprising one or more memories storing processor-executable code, and one or more processors coupled with the one or more memories and individually or collectively operable to execute the code to cause the UE to perform a method of any of aspects 1 through 17.

Aspect 33: A UE, comprising at least one means for performing a method of any of aspects 1 through 17.

Aspect 34: A non-transitory computer-readable medium storing code for wireless communication, the code comprising instructions executable by at least one processor (e.g., directly, indirectly, after pre-processing, without pre-processing) to perform a method of any of aspects 1 through 17.

Aspect 35: A network entity, comprising at least one processor; and memory coupled with the at least one processor, the memory storing instructions executable by the at least one processor to cause the network entity to perform a method of any of aspects 18 through 31.

Aspect 36: A network entity, comprising at least one means for performing a method of any of aspects 18 through 31.

Aspect 37: A non-transitory computer-readable medium storing code for wireless communication, the code comprising instructions executable by at least one processor (e.g., directly, indirectly, after pre-processing, without pre-processing) to perform a method of any of aspects 18 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein. Components within a wireless communications system may be coupled (for example, operatively, communicatively, functionally, electronically, and/or electrically) to each other.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), and ascertaining. Also, “determining” or “identifying” can include receiving (such as receiving information or signaling, e.g., receiving information or signaling for determining, receiving information or signaling for identifying), and accessing (such as accessing data in a memory, or accessing information). Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a first radio of the UE, an indication of one or more resources for reception of low-power synchronization signals associated with a second radio of the UE, wherein the second radio is associated with lower power consumption than the first radio;
receive, via the second radio, one or more low-power synchronization signals over the one or more resources in accordance with an idle mode of the UE; and
perform a cell reselection in accordance with receiving the one or more low-power synchronization signals while in the idle mode, wherein an association between the UE and one or more network entities is based at least in part on the cell reselection in accordance with receiving the one or more low-power synchronization signals.

2. The UE of claim 1, wherein the one or more processors are individually or collectively further operable to execute the code to cause the UE to:
perform a received power measurement on a low-power synchronization signal of the one or more low-power synchronization signals while in the idle mode, wherein performing the cell reselection is based at least in part on the received power measurement.

3. The UE of claim 2, wherein the one or more processors are individually or collectively further operable to execute the code to cause the UE to:
obtain a metric based at least in part on the received power measurement and a mapping between received power measurements of the one or more low-power synchronization signals and received power measurements of synchronization signal blocks, wherein performing the cell reselection is based at least in part on the metric.

4. The UE of claim 3, wherein the one or more processors are individually or collectively further operable to execute the code to cause the UE to:
receive, via the first radio, an indication of an offset between the received power measurements of the one or more low-power synchronization signals and the received power measurements of synchronization signal blocks, wherein the mapping is based at least in part on the offset.

5. The UE of claim 3, wherein the one or more processors are individually or collectively further operable to execute the code to cause the UE to:
receive, via the first radio, one or more synchronization signal blocks; and
perform a first calibration measurement on the one or more synchronization signal blocks and a second calibration measurement on the one or more low-power synchronization signals, wherein the mapping is based at least in part on a difference between the first calibration measurement and the second calibration measurement.

6. The UE of claim 1, wherein the one or more processors are individually or collectively further operable to execute the code to cause the UE to:
receive, via the first radio, system information that indicates a criterion for reception of the one or more low-power synchronization signals received on a serving cell; and
monitor for the one or more low-power synchronization signals on the serving cell based at least in part on the criterion being satisfied, wherein receiving the one or more low-power synchronization signals is based at least in part on the monitoring.

7. The UE of claim 6, wherein the criterion corresponds to a threshold signal strength of synchronization signal blocks received on the serving cell, or a mobility state of the UE, or both.

8. The UE of claim 1, wherein the one or more processors are individually or collectively further operable to execute the code to cause the UE to:
determine whether to perform measurements on low-power synchronization signals or synchronization signal blocks received on a serving cell based at least in part on a signal strength of the one or more low-power synchronization signals or a signal strength of one or more synchronization signal blocks, or both.

9. The UE of claim 8, wherein the one or more processors are individually or collectively further operable to execute the code to cause the UE to:
perform received power measurements on the low-power synchronization signals based at least in part on the signal strength of the one or more low-power synchronization signals satisfying a first threshold.

10. The UE of claim 8, wherein the one or more processors are individually or collectively further operable to execute the code to cause the UE to:
perform received power measurements on the low-power synchronization signals and the synchronization signal blocks based at least in part on the signal strength of the one or more low-power synchronization signals failing to satisfy a first threshold and the signal strength of the one or more synchronization signal blocks satisfying a second threshold.

11. The UE of claim 8, wherein, to receive the one or more low-power synchronization signals, the one or more processors are individually or collectively operable to execute the code to cause the UE to:
perform received power measurements on the synchronization signal blocks based at least in part on the signal strength of the one or more synchronization signal blocks failing to satisfy a third threshold.

12. The UE of claim 1, wherein, to receive the indication of the one or more resources, the one or more processors are individually or collectively operable to execute the code to cause the UE to:
receive, on a serving cell, system information that indicates a time and frequency location of resources for reception of low-power synchronization signals on the serving cell, or a non-serving cell, or both, wherein the one or more resources are based at least in part on the time and frequency location.

13. The UE of claim 1, wherein, to receive the indication of the one or more resources, the one or more processors are individually or collectively operable to execute the code to cause the UE to:
receive, on a serving cell, system information that indicates a time and frequency location of resources for reception of synchronization signal blocks on the serving cell, or a non-serving cell, or both, wherein the one or more resources are based at least in part on the time and frequency location.

14. The UE of claim 13, wherein the one or more processors are individually or collectively further operable to execute the code to cause the UE to:
receive, via the first radio, a synchronization signal block on the non-serving cell based at least in part on the system information; and
determine an availability of the non-serving cell for reception of the one or more low-power synchronization signals based at least in part on a received power of the synchronization signal block, wherein receiving the one or more low-power synchronization signals is based at least in part on the availability.

15. The UE of claim 1, wherein the one or more processors are individually or collectively further operable to execute the code to cause the UE to:
receive, via the first radio, system information that indicates a criterion for reception of the one or more low-power synchronization signals received on a non-serving cell; and
monitor for the one or more low-power synchronization signals on the non-serving cell based at least in part on the criterion being satisfied, wherein receiving the one or more low-power synchronization signals is based at least in part on the monitoring.

16. A method for wireless communications at a user equipment (UE), comprising:
receiving, via a first radio of the UE, an indication of one or more resources for reception of low-power synchronization signals associated with a second radio of the UE, wherein the second radio is associated with lower power consumption than the first radio;
receiving, via the second radio, one or more low-power synchronization signals over the one or more resources in accordance with an idle mode of the UE; and
performing a cell reselection in accordance with receiving the one or more low-power synchronization signals while in the idle mode, wherein an association between the UE and one or more network entities is based at least in part on the cell reselection in accordance with receiving the one or more low-power synchronization signals.

17. The method of claim 16, further comprising:
performing a received power measurement on a low-power synchronization signal of the one or more low-power synchronization signals while in the idle mode, wherein performing the cell reselection is based at least in part on the received power measurement.

18. The method of claim 17, further comprising:
obtaining a metric based at least in part on the received power measurement and a mapping between received power measurements of the one or more low-power synchronization signals and received power measurements of synchronization signal blocks, wherein performing the cell reselection is based at least in part on the metric.

19. The method of claim 18, further comprising:
receiving, via the first radio, an indication of an offset between the received power measurements of the one or more low-power synchronization signals and the received power measurements of synchronization signal blocks, wherein the mapping is based at least in part on the offset.

20. The method of claim 18, further comprising:
receiving, via the first radio, one or more synchronization signal blocks; and
performing a first calibration measurement on the one or more synchronization signal blocks and a second calibration measurement on the one or more low-power synchronization signals, wherein the mapping is based at least in part on a difference between the first calibration measurement and the second calibration measurement.
